(19) United States
(12) Patent Application Publication
(10) Pub. No.: US 2020/0327560 A1
(43) Pub. Date: Oct. 15, 2020

(54) MANAGE INFORMATION PERTAINING TO ANONYMOUS AND KNOWN CUSTOMER ACTIVITY

(71) Applicant: Comenity LLC, Columbus, OH (US)

(72) Inventors: Chris ANDERSON, Powell, OH (US); Jess LAWRENCE, Westerville, OH (US); Manoj Ram TAMMINA, Columbus, OH (US)

(73) Assignee: Comenity LLC, Columbus, OH (US)

(21) Appl. No.: 16/838,853

(22) Filed: Apr. 2, 2020

Related U.S. Application Data
(60) Provisional application No. 62/834,027, filed on Apr. 15, 2019.

(51) Int. Cl. G06Q 30/02; G06F 16/903

(52) U.S. Cl. CPC G06Q 30/0201; G06F 16/90335

(57) ABSTRACT

Managing information pertaining to anonymous and/or known customer activity is disclosed. When a retailer's website is accessed, ID information is obtained for the user's computing device. The ID information is used to search for a customer. Once a customer is identified, the browser information is obtained and added to a customer data file of the identified customer. Similarly, when a customer's mobile device has entered a physical store, a device ID for the mobile device will be obtained. The device ID is used to search for the customer associated with the device ID. Once identified, tracking information is obtained and added to the customer data file of the identified customer. The information in the customer data file is used to develop a customer profile for the identified customer based on all identified customer activity.

### CROSS-REFERENCE TO RELATED APPLICATIONS (PROVISIONAL)

This application claims priority to and benefit of co-pending U.S. Provisional Patent Application No. 62/834,027 filed on Apr. 15, 2019, entitled “TWO DEVICE AUTHENTICATION FOR A CREDIT APPLICATION” by Anderson et al., and assigned to the assignee of the present application, the disclosure of which is hereby incorporated by reference in its entirety.

### BACKGROUND

Presently, retailers do not have a good way of connecting their customers online and offline behaviors without a purchase. For example, a customer may browse a retailer's site on the internet, but the customer may not log in to their account with the retailer unless they are going to make a purchase. Thus, the customer's browsing information remains anonymous unless or until the customer logs into their account on the retailer's website.

Similarly, a customer may browse a retailer's physical location, but the customer may not provide any account identifying information to the retailer (such as a reward number, branded credit account, or the like) until they make a purchase. Thus, the customer's browsing in the store (and even the customer's visit(s) to the store) would remain anonymous unless or until the customer makes a purchase at the physical location, opens the retailer's application on the customer's mobile device, or otherwise identifies them self to the retailer.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1A is a block diagram of a mobile phone, in accordance with an embodiment.

FIG. 1B is a block diagram of a system to pre-populate and verify information on a credit application, in accordance with an embodiment.

FIG. 2A is a block diagram of a user specific information engine accessing one or more different search locations, in accordance with an embodiment.

FIG. 2B is a block diagram of a system for adding a new credit account with purchase capability to a mobile wallet, in accordance with an embodiment.

FIG. 3A is a flow chart of a method for mobile credit acquisition, in accordance with an embodiment.

FIG. 3B is a flow chart of a method for utilizing the device identifier and the user identifier to obtain user specific information, in accordance with an embodiment.

FIG. 3C is a flow diagram of a method for utilizing the new account in the mobile wallet of a mobile phone, to make a transaction, in accordance with an embodiment.

FIG. 4A is a screen capture of a web-based credit application as viewed on a user's computing device, in accordance with an embodiment.

FIG. 4B is a screen capture of a verification text to a user's mobile phone, in accordance with an embodiment.

FIG. 4C is a screen capture of a web-based credit application requesting the verification code as viewed on a user's computing device, in accordance with an embodiment.

FIG. 4D is a screen capture of a web-based credit application requesting the verification of found user information as viewed on a user's computing device, in accordance with an embodiment.

FIG. 4E is a screen capture of a web-based credit application providing the terms and conditions as viewed on a user's computing device, in accordance with an embodiment.

FIG. 4F is a screen capture of a new credit account as viewed on a user's computing device, in accordance with an embodiment.

FIG. 4G is a screen capture of a confirmation that the new credit account information has been sent to the user's mobile phone as viewed on a user's computing device, in accordance with an embodiment.

FIG. 4H is a screen capture of a text including instructions on putting the new account into the user's mobile wallet as seen on a user's mobile phone, in accordance with an embodiment.

FIG. 5 is a block diagram of an example fraud detection system, in accordance with an embodiment.

FIG. 6 is a flowchart of a method for using position location information to pre-populate information on a credit application, in accordance with an embodiment.

FIG. 7 is a flowchart of a method for using position location information to verify information on a credit application, in accordance with an embodiment.

FIG. 8 is a flow diagram for managing information pertaining to anonymous and/or known customers activity both in store and online, in accordance with an embodiment.

FIG. 9 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that the obtaining, accessing, or utilizing of information conforms to applicable privacy laws (e.g., federal privacy laws, state privacy laws, etc.).

### Overview

In general, application abandonment occurs when an applicant needs to fill out an application and the applicant quits filling out the application before providing all of the needed information. In other words, the more questions on an application that need answers, the more likely it will be that the applicant will abandon the application before completion. Thus, if the application is prepopulated with information, there will be fewer blanks for the applicant to fill in. The fewer blanks will allow the applicant to complete the application before becoming frustrated, distracted, overwhelmed, or the like. As such, the percentage of applicants completing the application form is inversely related to the number of keystrokes required by the applicant to complete the application.

The discussion provides a novel approach for seamlessly applying for and obtaining a new credit account. Moreover, after finding out information about the client, that information can be used for pre-population form filling when forms are provided to the user on the mobile phone. In other words, many fields in an application will be pre-populated which will reduce the amount of work a user has to do inputting the information.

In one embodiment, as will be described herein, a mobile credit acquisition with form population that differs significantly from the conventional processes used for consumers to apply for a credit account is disclosed. In conventional approaches, when filling out the forms to apply for credit, the consumer must key in a lot of information such as name, address, phone number, birthday, identification number, etc. Such conventional approaches are error prone, tedious, time-consuming, and often times a user will quit the process before it can be completed. Instead, the present embodiments, as will be described and explained below in detail, provide a previously unknown procedure for reducing the amount of data a consumer has to key by locating the consumer's name, address and other personal information via automated searches. Thus, embodiments of the present invention provide a streamlined method for mobile credit acquisition which extends well beyond what was previously done by hand.

Importantly, the embodiments of the present invention, as will be described below, provide an approach for seamlessly applying for and obtaining a credit account, which differs significantly from the conventional processes. As will be described in detail, the various embodiments of the present invention do not merely implement conventional mobile credit acquisition processes on a computer. Instead, the various embodiments of the present invention, in part, provide a previously unknown procedure for reducing the amount of data a consumer has to key by locating the consumer's name, address and other personal information via automated searches. Hence, embodiments of the present invention provide a novel process for mobile credit acquisition with form population which is necessarily rooted in computer technology to overcome a problem specifically arising in the realm of digital customer key fatigue.

Moreover, the embodiments do not recite a mathematical algorithm; nor do they recite a fundamental economic or longstanding commercial practice. Instead, they address a business challenge that has been born in the Internet-centric environment in order to overcome numerous problems specifically arising in the realm of off-site credit application and acceptance. In so doing, significant steps are removed from the customer's plate and the customer's time is saved.

Thus, the disclosed embodiments provide an increased fraud protection due to obtaining the customer information used in the application being obtained from a reliable source and auto filled into the application for the credit account.

In the following discussion, a mobile phone refers to a computing device that has ingrained telephony capability via a mobile carrier.

In contrast, a non-phone computing device refers to any computing device such as a laptop, desktop, notebook, or the like that does not have ingrained telephony capability via the mobile carrier. Thus, a computing device that utilizes only the Internet, Wi-Fi, or the like to make phone calls would be an example of a non-phone computing device.

In the following discussion, the term credit application is utilized. In general, a credit application obtains some sort of identification information about an applicant and uses the identification information to make a credit determination. For example, if a consumer wants to obtain a credit account, the consumer would have to provide, among other things, identifying information such as, there name, current address, current employer, etc. The identifying information would be used to perform a credit check of the consumer's credit history and qualifications based on the credit issuer's selection criteria. In one embodiment, the check may occur at one or more of a number of possible credit reporting agencies.

It should be appreciated that the obtaining or accessing of user information conforms to applicable privacy laws (e.g., federal privacy laws, state privacy laws, etc.) and applicable fair credit reporting act laws. In one embodiment, prior to accessing user information, the user affirmatively “opts-in” to the services described herein. For example, during the use of an issuer's credit application, the user is prompted with a choice to affirmatively “opt-in” to various services. As a result, any information is obtained with the user's prior permission. Moreover, depending on present or future credit account requirements, rules and regulations, the credit application aspects described herein may be more or less formal.

In one embodiment, if the application is mobile web based instead of a mobile app, the mobile web may not be able to access the GPS data on the mobile app. However, the mobile web may be able to use the location information provided by the communication provider (carrier) to obtain location data that is similar to the mobile phone GPS data. One way to obtain the information would be to use an API to push the carrier information to the mobile web application.

In one embodiment, the application is a non-integrated application, e.g., custom code is hosted and managed by credit account provider. In one embodiment, the application is an integrated application, e.g., it provide a brand the bones of the front end such that the brand can host and modify the front end based on their own individualized criteria, while the back end remains hosted and managed by the credit account provider. In one embodiment, the application is a hybrid, e.g., the credit account provider will host and manage but they will receive front end input/design/criterion from the brand that will be used by the credit account provider to customize the front end for the brand while both the front end and the back end remain hosted and managed by the credit account provider.

### Operation

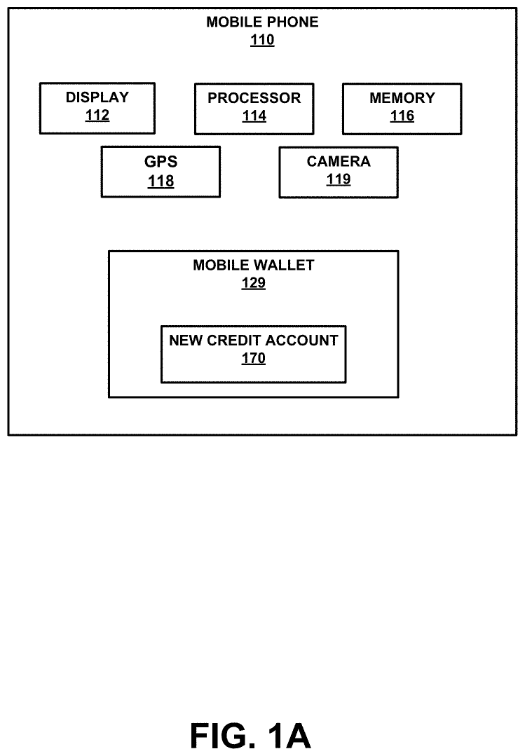

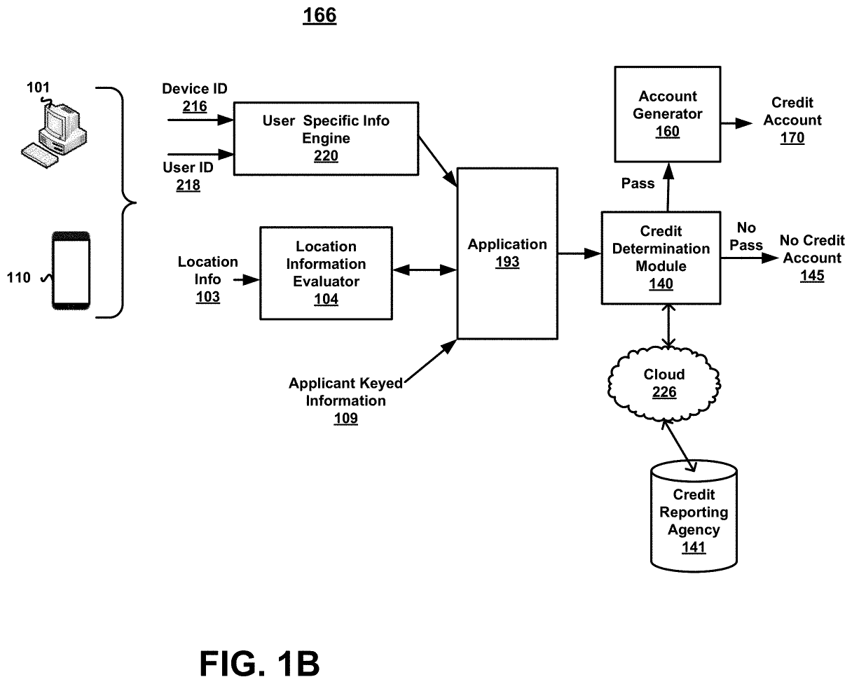

Referring now to FIG. 1A, a block diagram of a mobile phone 110 is shown. Although a number of components are shown as part of mobile phone 110, it should be appreciated that other, different, more, or fewer components may be found on mobile phone 110.

In general, mobile phone 110 is an example of a customer's mobile phone. Mobile phone 110 could be a mobile phone, a smart phone, a tablet, a smart watch, a piece of smart jewelry, smart glasses, or other user portable devices having wireless telephony connectivity via a mobile service provider. In one embodiment, mobile phone 110 is also capable of broadcasting and receiving via at least one network, such as, but not limited to, WiFi, Bluetooth, NFC, and the like. In one embodiment, mobile phone 110 includes a display 112, a processor 114, a memory 216, a GPS 218, a camera 119, and the like.

Mobile phone 110 also includes a mobile wallet 129 which is an electronic application that operates on mobile phone 110. Mobile wallet 129 includes new credit account 170. In general, new credit account 170 allows a customer to utilize a single mobile payment method that is linked to one or more credit account information, reward account information, offers, coupons, and the like, and is carried in a secure digital form on a mobile phone 110. Instead of using a physical plastic card to make purchases, a mobile wallet allows a customer to pay via mobile phone 110 in stores, in apps, or on the web.

GPS 218 can generate and provide location information with respect to the customer's mobile phone. The output from GPS 218 could be utilized by an operating system of mobile phone 110, an application (app) loaded on mobile phone 110, a web based app accessed over a network by mobile phone 110, or the like. In one embodiment, the output from GPS 218 could be provided to another computing system for identification purposes, fraud determination/evaluation, etc. In one embodiment, instead of providing GPS information, the location of mobile phone 110 may be determined within a given radius, such as the broadcast range of an identified beacon, a WiFi hotspot, overlapped area covered by a plurality of mobile telephone signal providers, or the like.

With reference now to FIG. 1B, a block diagram of a system 166 for obtaining and verifying information on a credit application 193 is shown in accordance with an embodiment. System 166 includes a non-phone computing device 101, a mobile phone 110 having a mobile application installed thereon, location information 103, applicant keyed information 109, location information evaluator 104, user specific information engine 220, and application 193.

Application 193 could be initiated by text links, URLs, NFC, beacon, WiFi, RFID, scannable 2D codes, etc. In general, 2D codes include aspects such as visual images, QR code, and the like.

In one embodiment, the location information could be the location of the mobile phone or non-phone computing device. In one embodiment, the location of the mobile phone or can be determined via geo-fence, beacon range, a ping, NFC, WiFi, or the like. Moreover, the location may be an actual location or a relative location.

For example, actual location information may be obtained by the user's mobile phone location services, such as but not limited to, GPS, WiFi, cellular service, beacon derived location determination, and the like. Moreover, the location determination can be useful even at differing levels of accuracy. For example, a GPS enabled mobile phone would provide location information that is accurate to within a few meters and would be lat long coordinates (or similar).

In contrast, relative location information is location information determined via a broadcasting or receiving station (e.g., cellular service, beacon, WiFi access point, hotspot, or the like). The relative location would be the location of the station and a broadcast radius (or area) of coverage for the station. Moreover, if the device is picked up by two or more different stations, then the location could be further refined as being within the overlapping broadcast radii of the number of different stations. For example, although the actual location of mobile phone may not be known, if the mobile phone is interacting with a beacon X, then the relative location of the mobile phone would have to in range of beacon X broadcast radius. Similarly, a geo-fence could be used to determine that the location of mobile phone is within the defined geo-fenced area, although the actual location of the mobile phone within the geofenced area may not be known.

In one embodiment, mobile phone 110 will use a positioning determining system such as global positioning system (GPS) or the like to determine location information 103. In another embodiment, the mobile phone may be able to determine a location within a given radius, such as the broadcast range of a beacon, WiFi hotspot, overlapped area covered by a plurality of mobile telephone signal providers, or some combination thereof.

Application 193 is a web based application accessed at a web site, from an application store, by scanning a visual code such as a barcode, a QR code on a physical item such as a poster, or the like. In another embodiment, the web-based location of application 193 is received by a beacon broadcast, WiFi broadcast, email, or the like. In one embodiment, application 193 obtains authorization from mobile phone 110 to access location information 103 on the mobile phone 110.

Location information 103 refers to the location of the mobile phone 110 at different times of the day as generated by a positioning system on the mobile phone 110, by location information on the user's home computer system or the like. Because of the different positioning systems available on a mobile phone and/or a non-phone computing device, the location information 103 can include differing levels of accuracy. For example, a GPS enabled mobile phone 110 can provide location information 103 that is accurate to within a few meters or less. In contrast, location information 103 derived from cellular service, beacon, WiFi location capabilities, and the like can provide a location radius or location area that may be within 10-50 meters or even larger.

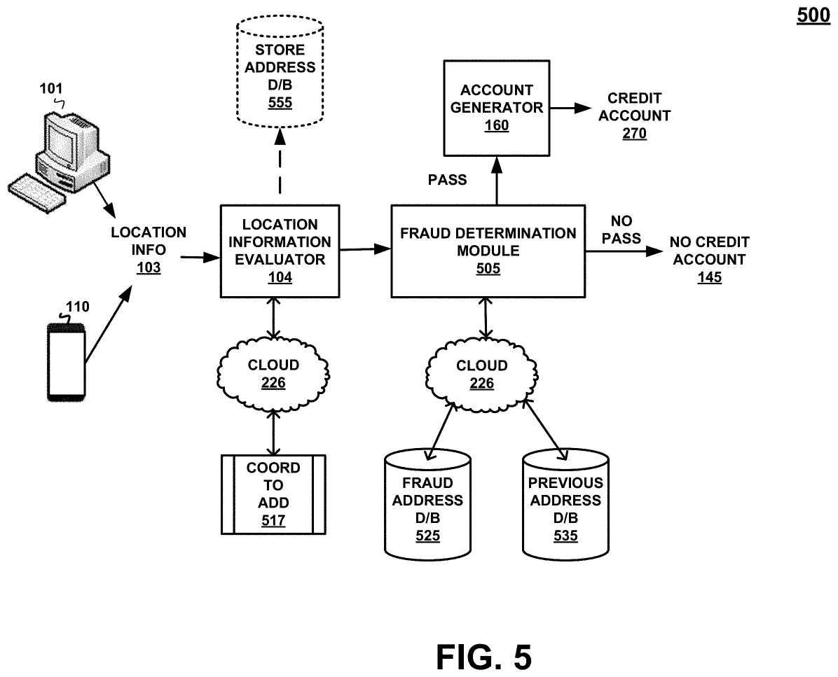

Location information evaluator 104 uses location information 103 to determine an actual address. For example, in one embodiment, the location information 103 provided by mobile phone 110 are provided as coordinates data. In order to determine an address, location information evaluator 104 cross-references the coordinate data with one or more different coordinate-to-address determination sources such as: mapping software, surveyor data that includes business and/or residential information, County assessor's information, or other coordinate-to-address determiners. Further operation of location information evaluator 104 is shown and described in FIG. 5.

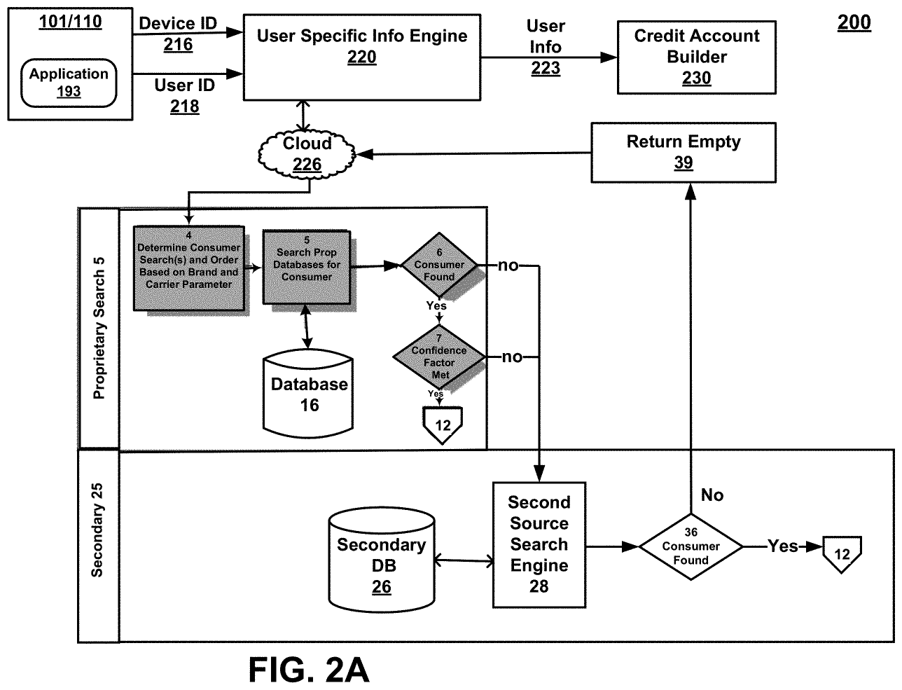

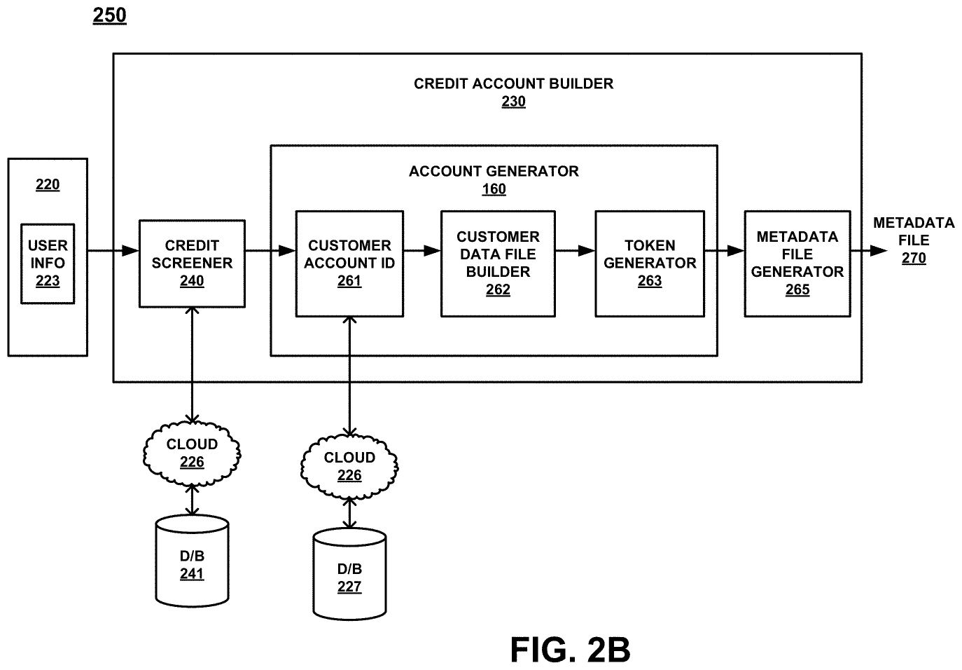

User specific information engine 220 receives a device ID 216 and/or a user ID 218 and utilizes the ID's to obtain user specific information useable to prepopulate application 193. The operation of user specific information engine 120 is discussed in more detail in the discussion of FIGS. 2A-2B.

Applicant keyed information 109 refers to information that is keyed/typed or otherwise input into application 193.

In one embodiment, the location information determined by location information evaluator 104, and the user specific information provided by the user specific information engine 220 is prefilled into the application 193. By pre-populating application 193 prior to presenting it to the applicant, the abandonment rate will be improved as the application 193 completion process is reduced. Moreover, the amount of required applicant keyed information 109 will be reduced.

In general, credit determination module 140 accesses a credit reporting agency 141 via cloud 226 to determine credit information for the user based on the application information. An example of cloud 226 is a network such as described herein. The credit reporting agency 141 may be a company such as, but not limited to, Experian, Equifax, TransUnion, Innovis and the like.

Credit determination module 140 will analyze the user's credit information provided by credit reporting agency 141 to determine if the user passes the criteria established to obtain a credit account. In one embodiment, credit determination module 140 will also determine a credit account limit. For example, the credit account limit may be 1000.00 USD.

If the user does not pass the criteria established to obtain a credit account, no credit account 145 is established and no further action is taken.

If the user does pass the credit criteria established to obtain a credit account, the applicant's information is passed to account generator 160 and a credit account 270 is generated. In one embodiment, credit account generator 160 provides a digital credit account 270 identifier to the mobile phone. In one embodiment, the digital credit account identifier is instantly available to be used as a form of payment.

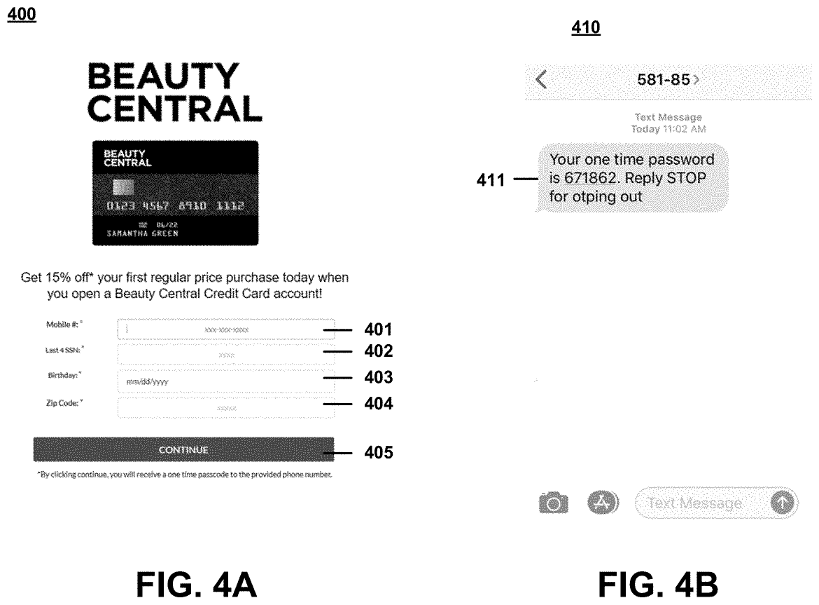

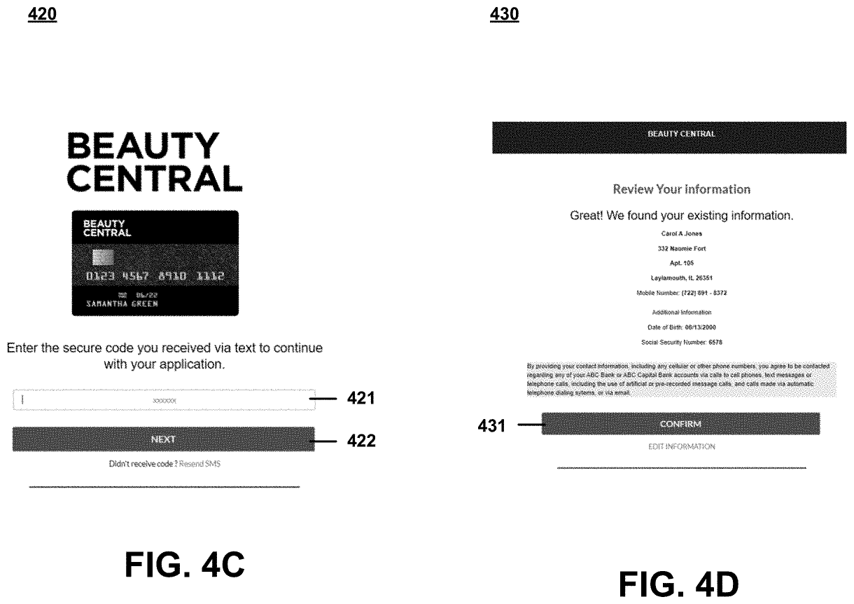

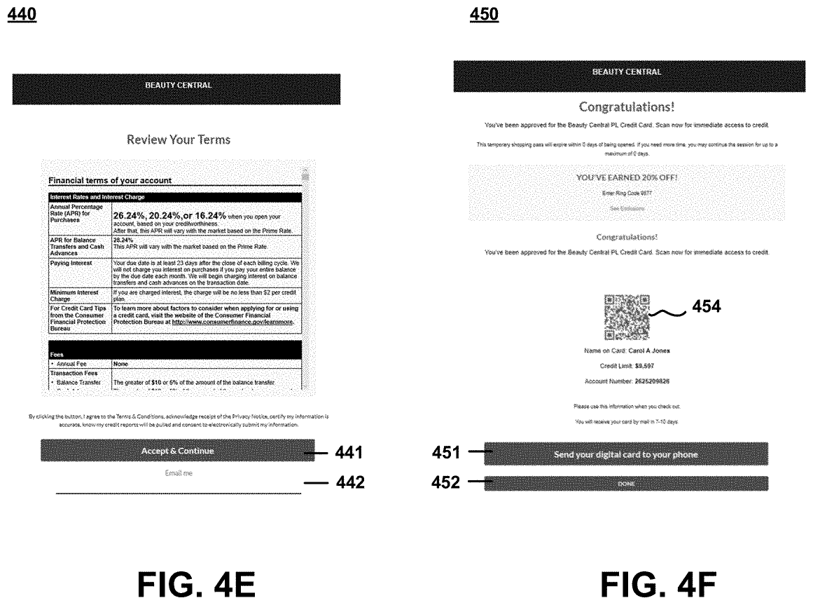

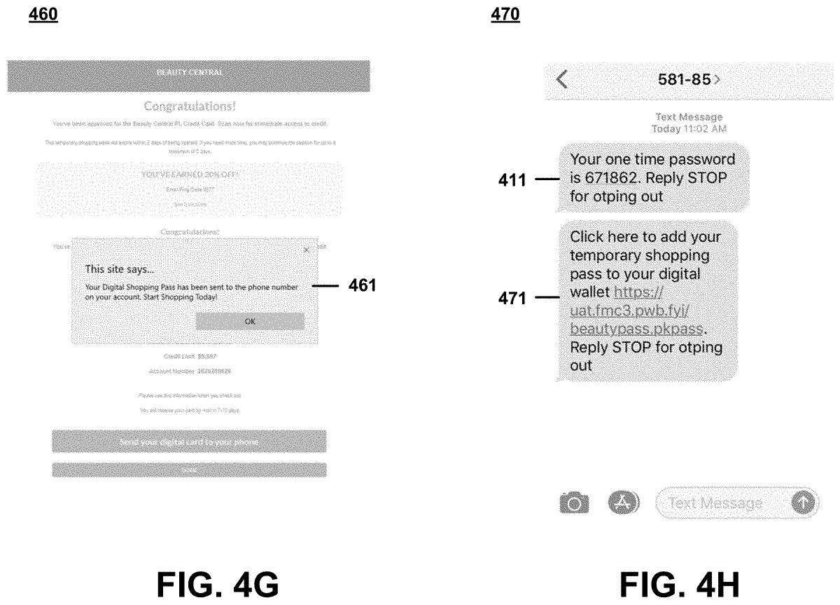

One example of a digital credit account identifier is a temporary shopping pass displayed on the display of the mobile phone. In one embodiment, the temporary shopping pass includes aspects such as: the user's name, credit limit, store card account number, terms of use for the temporary shopping pass, a rotating GIF to prevent screenshots from being accepted at POS, a banner asking customer to present their ID to the associate to use the temporary account, and the like. These are shown in further detail in FIG. 4F.

Referring now to FIG. 2A, a block diagram of a mobile credit acquisition system 200 is shown in accordance with an embodiment. In one embodiment, mobile credit acquisition system 200 includes an credit application 193, a user specific information engine 220, and a credit account builder 230. Although a number of applications and components are shown in mobile credit acquisition system 200, it should be appreciated that the components and applications may be located separately from one another. For example, one or more of the components and applications may be found on one or more locations, such as, but not limited to a computer in the retail store, a server at a remote location, on the cloud 226 or the like.

In general, credit application 193 is an incentive offer for a user intended to be redeemed via a user's mobile phone. For example, credit application 193 may be a digitally redeemable incentive, an offer for a credit account, or the like. For example, the offer may be a discount percentage, a free gift, a coupon, a surprise gift, a surprise reward, or the like. Credit application 193 may be located on a physical item such as a poster, or the like and include a visual code such as a barcode, a QR code, a number to text, an email address to reply to, or the like. In another embodiment, credit application 193 is received by the user's mobile phone, e.g., via a beacon broadcast, WiFi broadcast, email, text, SMS, social media alert, app alert, or the like. In yet another embodiment, credit application 193 may be provided by an app on the user's mobile phone once the mobile phone is within a certain vicinity of the store providing the offer.

A number of different options may be available to respond to the credit application 193. For example, the response may be in the form of a message interaction such as shown and described in further detail in FIGS. 4A through 4C. In one embodiment, the response to the offer includes providing a mobile phone ID 216 and a user ID 218.

In general, device ID 216 can be different depending upon the device. For example, a mobile phone device ID: includes identification characteristics such as, a mobile phone telephone number or mobile phone ID such as the mobile phone's serial number, international mobile equipment identity (IMEI), integrated circuit card identifier (ICCID) (e.g., the SIM card number), mobile equipment identifier (MEID), secure element chipset identify (SEID), or the like.

Non-phone computing device ID: includes identification characteristics such as a media access control (MAC) address, Internet protocol (IP) address, universal unique identifier (UUID), model number, product number, serial number, or the like.

In one embodiment, device ID 216 that is requested for the process is based upon an evaluation of which of the possible device ID's would provide the best capability for fraud prevention. For example, a user's mobile number could be easily obtained (e.g., via social media, public records, white pages, Internet search, etc.) so it would be a lower device ID option on a fraud scale. In contrast, the user's mobile phone serial number, international mobile equipment identity (IMEI), integrated circuit card identifier (ICCID) (e.g., the SIM card number), mobile equipment identifier (MEID), secure element chipset identify (SEID), or the like could is much less likely to be obtained fraudulently (via social media, public records, guessed, etc.) so it may be that one of the IMEI, ICCID, MEID, SEID, or the like would be the device ID with the highest fraud prevention value.

User ID 218 can be the user's identification information such as, name, zip code, social security number or portion thereof, driver's license number or portion thereof, or the like that is used to identify a specific user.

In one embodiment, the user ID 218 that is requested for the process is based upon an evaluation of which of the possible user ID's would provide the best capability for fraud prevention. For example, a user's birthday could be easily obtained (e.g., via social media, public records, etc.) so it would be a lower user ID option on a fraud scale. Similarly, a user's address could be easily obtained (e.g., via social media, public records, etc.) so it would also be a lower user ID option on a fraud scale. Further, a user's email could be easily obtained (e.g., via social media, public records, etc.) or easily guessed, so it would also be a lower user ID option on a fraud scale. In contrast, a social security number (or last four, six, seven, five, middle three, five, first 6, 7; middle three+last two; or any other amount or combination of the nine social security numbers) is much less likely to be obtained fraudulently (e.g., via social media, public records, guessed, etc.) so it may be that a pre-selected portion of the SSN (or a changing selected portion of the SSN) would be the user ID with the highest fraud prevention value.

Thus, a user's response to credit application 193 will include enough information for the mobile credit acquisition system 200 to perform a credit account qualification of the user for purposes of providing the user with a new credit account.

In one embodiment, user specific information engine 220 will receive a message from a user's mobile phone 110 in response to the credit application 193. The message will include device ID 216 and user ID 218.

In one embodiment, user specific information engine 220 will use device ID 216 and user ID 218 to obtain user specific information 223 to prepopulate an electronic form such as a credit application. In general, user specific information 223 could be at least two of: a name and full or partial address, a driver's license number, a social security number, or the like.

For example, user specific information engine 220 may access the different search locations via the cloud 226. An example of cloud 226 is a network such as the Internet, local area network (LAN), wide area network (WAN), or the like.

One embodiment uses the device ID 216 and user ID 218 information to perform a proprietary search 5 of at least one proprietary database 16. In general, the proprietary database 16 may be one or more databases such as a credit accounts database, or the like, that store a company's private database such as an Alliance Data Legacy database or the like. Proprietary database 16 will include user specific information 223 for customers that have existing accounts with the company, have previously applied for an account, or the like.

In one embodiment, the proprietary search 5 will only search a database related to a specific company. For example, if the credit account builder is a specific company, e.g., Nash's skate and bike emporium, then in a company specific database search, only the existing customer information related to Nash's skate and bike emporium will be searched. For example, a check is performed to see if the customer has an existing brand account, e.g., is already an existing customer in the database.

However, if the proprietary search 5 is for a group of companies, a shared information database, or the like, then all of the customer information in the databases may be searched for a match with the device ID 216 or the user ID 218. For example, if the database includes Nash's skate and bike, Mike's hardware, and Tarrin's dress stores, and all three companies are sharing information, then the search would encompass all three store's databases of information.

For example, search an internal accountholder database 16 to see if the consumer has another account within the shared information database. For example, if the customer does not have a Nash's skate and bike account, the underlying credit account, e.g., Alliance Data database is searched to see if the customer has an account at a different brand associated with Alliance Data.

In one embodiment, consumer information 6 that is found in the proprietary database 16 will be verified using a confidence factor 7. For example, if only one record is found and it is 5 days old, the confidence in the found records would likely be below a confidence threshold. In contrast, if 2 years of records are found, records such as prior accounts, present accounts, memberships, rewards information, and the like, then the confidence in the user specific information 223 found in the records would be above the confidence factor threshold. If the user specific information 223 is above the confidence threshold, then the user specific information 223 is deemed valid. At that point, the user specific information 223 is returned via return information 12 to user specific info engine 220 and then passed on to credit account builder 230.

One embodiment incorporates one or more of several fraud mitigation business rules to attempt to prevent fraudulent activity; e.g., to validate the found records. These business rules include logic that look at specific activity on a consumer's account that point to potentially fraudulent activities. In addition, fraud mitigation tool may be implemented. The fraud mitigation tool will use device and internet protocol (IP) information to predict if the credit application can be trusted or will eventually become fraudulent.

For example, in one embodiment, the fraud mitigation will ignore any credit accounts that meet situations such as, but not limited to, the following. It is associated within a brand(s) that have been determined to have a high propensity for fraud. It is currently in a derogatory status. The account was opened within a defined number of days, where the number of days is controlled by internal parameter and can be tightened, loosened or turned off. The phone number matched has been changed within a defined number of days, where the number of days is controlled by internal parameter and can be tightened, loosened or turned off. An authorized buyer has been added to the account within a defined number of days, where the number of days is controlled by internal parameter and can be tightened, loosened or turned off. The address has been changed within a defined number of days, where the number of days is controlled by internal parameter and can be tightened, loosened or turned off. The account has been inactive within a defined number of months, where the number of months is controlled by internal parameter and can be tightened, loosened or turned off. Multiple accounts are found for the mobile phone number, zip code and last 4 digits of the SSN but all accounts are not the same person; and the like.

If no user specific information 223 is found during the proprietary search 5 or if the found user specific information 223 cannot be validated, then the device ID 216 and user ID 218 are passed on to a secondary search 25. At secondary search 25, a second source search engine 28 will search at least one secondary source database 26. One example of secondary source database 26 is a reverse phone number look up such as reverse phone look-up. However, other secondary source databases may be searched such as, but not limited to: social media sites, search engines, online public and/or private records, reverse name and phone number engines, and the like. In one embodiment, the user specific information 223 may be obtained by performing a secondary source database 26 search with the user ID 218 and the device ID 216.

In one embodiment, the secondary search 25 may be for example, a real-time call to a reverse phone look-up product to try and locate the consumer. In general, reverse phone look-up products provide accurate and current consumer telephone information. In many cases, the data is updated regularly from a broad range of sources, including regional bell operating companies, white pages and proprietary sources. One embodiment also integrates validation and authentication aspects that add further benefits to append address information for a consumer. In general, validation and authentication aspects match consumer name and zip code information that was returned from the reverse phone look-up, against data from a secondary source to return full address data.

If consumer information 36 is found, then the user specific information 223 is returned via return information 12 to user specific info engine 220. If no user specific information 223 is found from the secondary search 25, then no user specific information 223 will be pre-populated into the forms. That is, the user specific info engine 220 will receive a return empty 39. However, if a match is made, then the user specific information 223 can be used to prepopulate a portion of the application. E.g., name, address, city, state, zip, mobile phone number, email, etc. of the application.

This is a benefit of the mobile credit acquisition with form population capability. Utilizing the form population reduces the amount of data a consumer has to key by locating the consumer's name and address via automated searches.

In one embodiment, when a consumer has to enter or change their address and begins to type their address, a search is invoked that returns a list of potential results based on the zip code that was entered in the initial user experience. As more characters are typed the picklist is refined to display closer matches. When the address is selected, it will be checked for completeness and the associated city and state will be auto pre-filled

Referring now to FIG. 2B, a block diagram of a system 250 for adding a new credit account with purchase capability to mobile wallet 129 of a customer's mobile phone 110 is shown in accordance with an embodiment. In one embodiment, system 250 shows the user specific information engine 220 providing the user specific information 223 to credit account builder 230 is shown in accordance with one embodiment. In one embodiment, credit account builder 230 includes a credit screener 240, a new credit account generator 160, and a metadata file generator 265. Although a number of applications and components are shown, it should be appreciated that there may be more of fewer components and applications of credit account builder 230. Moreover, different pieces may be combined, re-organized, located separately from one another, or the like.

In general, credit screener 240 accesses a database 241, such as a credit reporting agency, via cloud 226 to determine credit information for the user based on the user specific information 223. An example of cloud 226 is a network such as described herein. The credit reporting agency could be a company such as, but not limited to, Experian, Equifax, TransUnion, Innovis and the like.

Credit screener 240 will analyze the user's credit information obtained from the credit reporting agency database 241 to determine if the user passes a credit criteria. If the user does not pass the credit screening process, no further action is taken by mobile credit acquisition system 250.

In one embodiment, after the user passes the credit screening then credit account builder 230 provides an application for a credit account to the user's mobile phone. In one embodiment, credit account builder 230 populates the application for a credit account with the user specific information 223 as shown in 437 of FIG. 4C. That is, credit account builder 230 will place the user specific information 223 provided by the user specific information engine 220 into the forms that are provided to the user's mobile phone. By populating the forms prior to presenting them to the user, the abandonment rate will be improved as the acceptance process will be shortened due to the pre-filling of the customer's information into the acceptance forms.

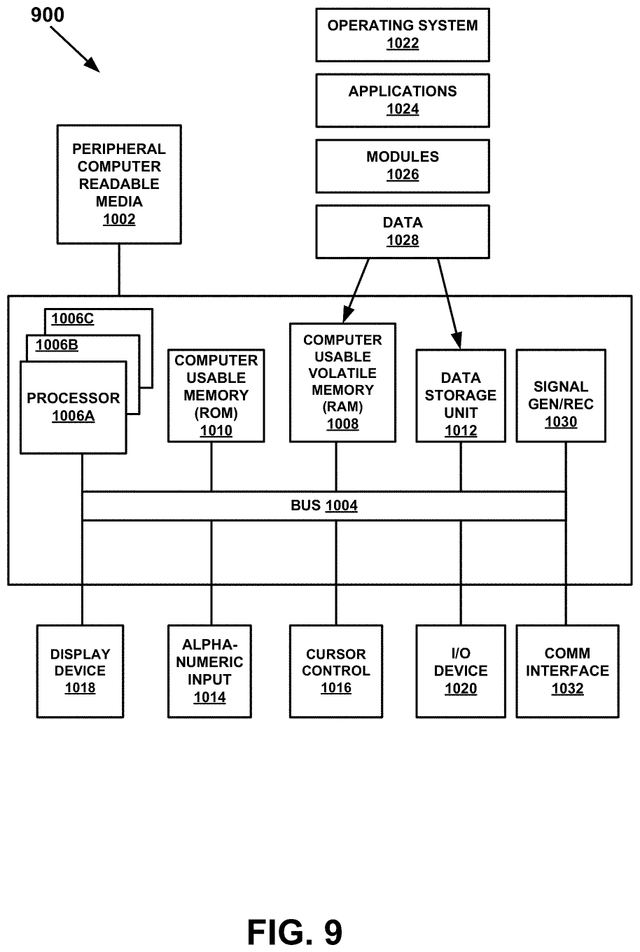

In one embodiment, credit account builder and/or new credit account generator 160 are computing systems similar to computer system 900 described in detail in the FIG. 9 discussion herein. In one embodiment, new credit account generator 160 includes a customer account identifier 261, a customer data file builder 262, a token generator 263, and a metadata file generator 265.

In one embodiment, once the user completes the new credit account application, new credit account generator 160 will receive the information in the new credit account application from credit screener 240.

In one embodiment customer account identifier 261 accesses database 227 which stores a plurality of customer credit accounts and utilizes the user specific information 223 in order to identify any other accounts related to the customer. In one embodiment, customer account identifier 261 accesses database 227 via cloud 226. An example of cloud 226 is a network such as the Internet, local area network (LAN), wide area network (WAN), or the like. Database 227 may include store specific data, brand specific data, retailer specific data, a shared database, a conglomerate database, a portion of a larger storage database, and the like. Moreover, database 227 could be a local database, a virtual database, a cloud database, a plurality of databases, or a combination thereof.

In one embodiment, database 227 stores a plurality of customer credit accounts, a plurality of customer reward accounts and/or offers, coupons, and the like. Customer account identifier 261 searches database 227 for one or more customer accounts (e.g., credit accounts, reward accounts, and/or offers, coupons, and the like) that are held by the identified customer. If any other customer accounts are found, they are provided by the customer account identifier 261 to customer data file builder 262 which links the one or more customer accounts with the new credit account information to build a customer data file.

Token generator 263 then generates a token identifying the customer data file. In one embodiment the token is an identification number, hash, or other type of anti-tamper encrypted protection that is generated as an identifier for the customer data file.

Metadata file generator 265 generates a metadata file 270 formatted for mobile wallet 129, the metadata file 270 including the new credit account 170 and the token. In one embodiment, the new credit account 170 could include an image and the token is embedded within the image data. In another embodiment, the token could be separate from the image that is presented when new credit account 170 is accessed and would be provided at the time of the transaction. For example, the token could be provided via a near field communication (NFC) between the mobile phone 110 and the POS when new credit account 170 is presented at the POS. In another embodiment, the entire new credit account 170 metadata file 270 could be provided via NFC at the time of the transaction and no imagery would be obtained by the POS even if it was presented on the display 112. In one embodiment, metadata file 270 includes an instruction that causes the new credit account 170 to be placed in a first location of mobile wallet 129 on the customer's mobile phone 110.

The metadata file 270 is then provided from the credit account builder 230 (e.g., a credit provider computer system, third-party computing system, or the like) to the customer's mobile phone 110. The metadata file 270 is added to mobile wallet 129 on the customer's mobile phone 110, wherein an access of the metadata file 270 in the mobile wallet causes the new credit account 170 to be presented by the customer's mobile phone 110. In general, the presentation of new credit account 170 by the customer's mobile phone 110 could be audible, visual, or the like, to provide payment at a time of a customer purchase as described herein.

In one embodiment, new credit account 170 is instantly available to be used as a form of payment. Additional details regarding the digital credit account identifier are shown and described with reference to FIGS. 4A through 4H herein.

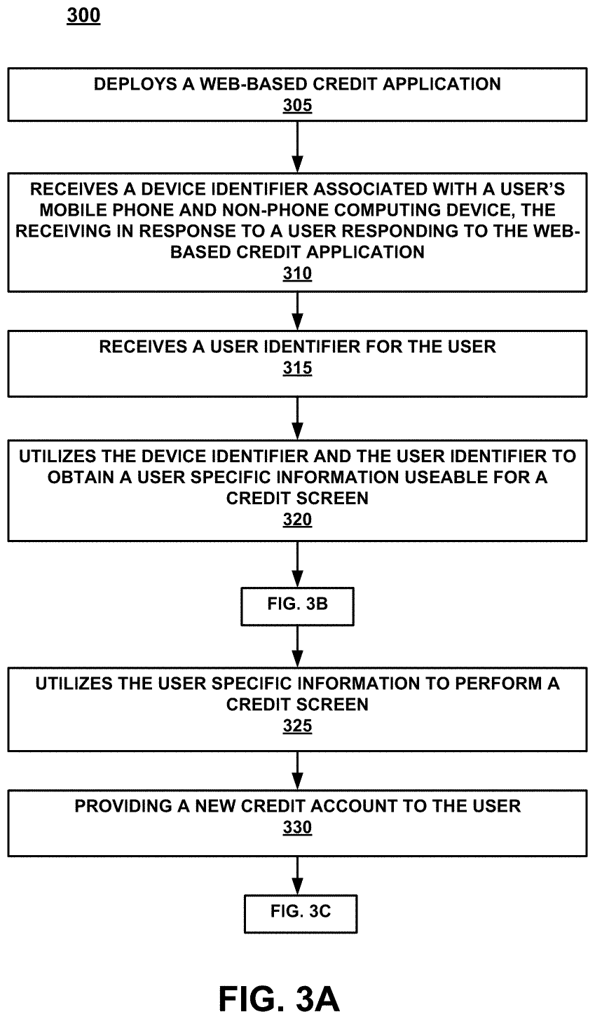

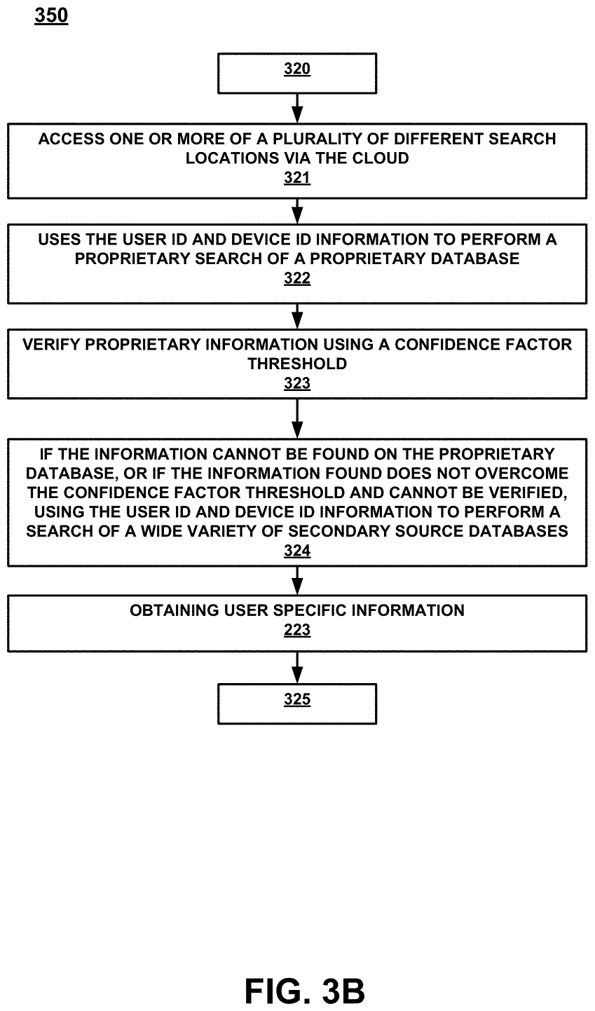

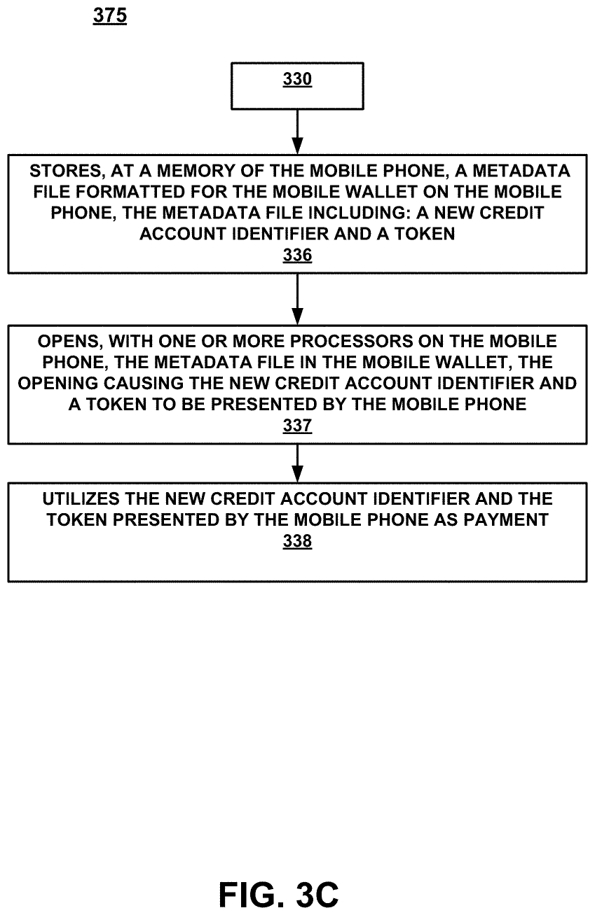

With reference now to FIG. 3A, a flowchart 300 of a method for mobile credit acquisition is shown in accordance with an embodiment. FIGS. 4A through 4H are also utilized to provide clarity and support for the discussion of flowchart 300.

Flowchart 300 provides a credit application experience that works in a similar fashion regardless of whether the credit application experience is occurring on a mobile phone, on a non-phone computing device, or via a combination of both the mobile phone and the non-phone computing device. For example, the application experience could be handed off from the user's mobile phone to a non-phone computing device, or from the non-phone computing device to the user's mobile phone.

In one embodiment, the user accesses the credit application system via a mobile web. The application system can determine via device detection, if the customer began the application process from a mobile phone or if the customer began the application process on a non-phone computing device.

FIG. 4A is a screen capture 400 of a web-based credit application as viewed on a user's computing device shown in accordance with an embodiment. FIG. 4B is a screen capture 410 of a verification text to a user's mobile phone shown in accordance with an embodiment. FIG. 4C is a screen capture 420 of a web-based credit application requesting the verification code as viewed on a user's computing device shown in accordance with an embodiment. FIG. 4D is a screen capture 430 of a web-based credit application requesting the verification of found user information as viewed on a user's computing device shown in accordance with an embodiment. FIG. 4E is a screen capture 440 of a web-based credit application providing the terms and conditions as viewed on a user's computing device shown in accordance with an embodiment. FIG. 4F is a screen capture 450 of a new credit account as viewed on a user's computing device shown in accordance with an embodiment. FIG. 4G is a screen capture 460 of a confirmation that the new credit account information has been sent to the user's mobile phone as viewed on a user's computing device shown in accordance with an embodiment. FIG. 4H is a screen capture 470 of a text including instructions on putting the new account into the user's mobile wallet as seen on a user's mobile phone shown in accordance with an embodiment. Although a number of different pages are shown, it should be appreciated that the pages could be combined, reordered, skipped, more pages added, or the like. The use of FIGS. 4A-4H is one embodiment, that provides clarity for the discussion.

Although the interactions between user's computing devices and the web-based application are shown in the format of text messages and screen captures, it should be appreciated that the interactions may be made via one or more of: a beacon broadcast, WiFi broadcast, email, text, SMS, social media alert, app alert, or the like.

With reference now to 305 of FIG. 3A, one embodiment deploys a web based credit application 193. In one embodiment, credit application 193 is an offer to open a new credit account with the retailer, or the like. In one embodiment, credit application 193 may be an offer to open a new reward account, or the like.

For example, information for accessing credit application 193 can be distributed on a physical item such as a poster, or the like that includes a visual code such as a barcode, a QR code, a number to text, an email address to reply to, or the like. In another embodiment, information for accessing credit application 193 is received by the user's mobile phone or non-phone computing device, e.g., via a beacon broadcast, WiFi broadcast, email, text, SMS, social media alert, app alert, or the like. In yet another embodiment, information for accessing credit application 193 is provided by an app on the user's mobile phone that will present credit application 193 once the mobile phone is within a certain vicinity of the store providing the offer.

For example, as shown in FIG. 4A web page 400 includes a brand (beauty central) and an offer to open a new credit account. The web-based credit application includes a request for a mobile phone number 401, the last four of the SSN 402, a birthdate 403, and a zip code 404. Although a number of different requests are made, it should be appreciated that more or fewer questions may be initially requested by the application on web page 400.

With reference now to 310 of FIG. 3A, one embodiment receives a device identifier associated with a user's mobile phone 110 or non-phone computing device 101. As stated herein, device ID 216 can be different depending upon the device. For example, a mobile phone device ID: includes identification characteristics such as, a mobile phone telephone number or mobile phone ID such as the mobile phone's serial number, international mobile equipment identity (IMEI), integrated circuit card identifier (ICCID) (e.g., the SIM card number), mobile equipment identifier (MEID), secure element chipset identify (SEID), or the like. Non-phone computing device ID: includes identification characteristics such as a media access control (MAC) address, Internet protocol (IP) address, universal unique identifier (UUID), model number, product number, serial number, or the like.

In one embodiment, device ID 216 that is requested for the process is based upon an evaluation of which of the possible device ID's would provide the best capability for fraud prevention. For example, a user's mobile number could be easily obtained (e.g., via social media, public records, white pages, Internet search, etc.) so it would be a lower device ID option on a fraud scale. In contrast, the user's mobile phone serial number, international mobile equipment identity (IMEI), integrated circuit card identifier (ICCID) (e.g., the SIM card number), mobile equipment identifier (MEID), secure element chipset identify (SEID), or the like could is much less likely to be obtained fraudulently (via social media, public records, guessed, etc.) so it may be that one of the IMEI, ICCID, MEID, SEID, or the like would be the device ID with the highest fraud prevention value.

For example, as shown in FIG. 4B, a one-time password 411 is sent to the user's mobile phone based on the phone number provided at 401 of FIG. 4A. In one embodiment, when the information put into FIG. 4A is sent, the non-phone computing device ID 216 will be sent as part of the metadata. In one embodiment, when the text is received, the user's mobile phone device ID 216 will be obtained via a request included in the text metadata.

With reference now to 315 of FIG. 3A, one embodiment receives a user identifier for the user. User ID 218 can be the user's identification information that was provided in FIG. 4A. In one embodiment, the user ID 218 that is requested on the page displayed in FIG. 4A is based upon an evaluation of which of the possible user ID's would provide the best capability for fraud prevention. For example, a user's birthday could be easily obtained (e.g., via social media, public records, etc.) so it would be a lower user ID option on a fraud scale. Similarly, a user's address could be easily obtained (e.g., via social media, public records, etc.) so it would also be a lower user ID option on a fraud scale. Further, a user's email could be easily obtained (e.g., via social media, public records, etc.) or easily guessed, so it would also be a lower user ID option on a fraud scale. In contrast, a social security number (or last four, six, seven, five, middle three, five, first 6, 7; middle three+last two; or any other amount or combination of the nine social security numbers) is much less likely to be obtained fraudulently (e.g., via social media, public records, guessed, etc.) so it may be that a pre-selected portion of the SSN (or a changing selected portion of the SSN) would be the user ID with the highest fraud prevention value.

For example, as shown in FIG. 4A, the user accesses a company web page that asks the user to provide a zip code, birthday, and a last four of a social security number as the user ID 218. Although the last four of a social is shown as the user ID 218, it should be understood that the user ID 218 may be something other than the last four of a social security number, such as user's zip code, entire or a different portion of a social security number, the driver's license number or portion thereof, or the like; that is used to identify a specific user. In one embodiment, the company page 400 is a web page, a micro page or the like. After the user submits a response to page 400, the user ID 218 will be received.

Similarly, at FIG. 4C, the web-based credit application requests the verification code response 421 and once it is entered, in one embodiment, the user will click on the next 422.

### Customer Information Acquisition

With reference now to 320 of FIG. 3A and as shown and expanded in the flowchart 350 of FIG. 3B and shown in FIGS. 2A and 2B, one embodiment utilizes device ID 216 and user ID 218 to obtain user specific information 223 useable for a credit screen and/or to prepopulate an electronic form such as a credit application. In general, user specific information 223 could be one or more of: a name and full or partial address, a driver's license number, a social security number, or the like.

As shown at 321 of FIG. 3B, user specific information engine 220 may access one or more of a plurality of different search locations via the cloud 226. An example of cloud 226 is a network such as the Internet, local area network (LAN), wide area network (WAN), or the like.

As described at 322 of FIG. 3B, one embodiment uses the device ID 216 and user ID 218 information to perform a proprietary search 5 of a proprietary database 16. In general, the proprietary database 16 may be one or more databases that store a company's private database such as an Alliance Data Legacy database or the like. Proprietary database 16 will include user specific information 223 for customers that have existing accounts with the company, have previously applied for an account, or the like.

With reference now to 323 of FIG. 3B, in one embodiment, user specific information 223 that is found in the proprietary database 16 will be verified using a confidence factor threshold. For example, a confidence factor determination will be made by looking at the returned records to determine a confidence value. For example, if only one record is found and it is 5 days old, the confidence in the found records would likely be below the confidence value threshold. In contrast, if 2 years of records are found, records such as prior accounts, present accounts, memberships, rewards information, and the like, then the confidence value in the user specific information 223 found in the records would be above the confidence factor threshold. If the user specific information 223 does pass the confidence threshold, then the user specific information 223 is returned via return information 12 to user specific info engine 220 and then passed on to credit account builder 230 as discussed and shown in FIG. 2B.

With reference now to 324 of FIG. 3B, if the user specific information 223 cannot be found on the proprietary database, or if the user specific information 223 found does not overcome the confidence factor threshold, one embodiment uses the user ID 218 and device ID 216 information to perform a search of a secondary source database 26. Examples of secondary source databases include Internet engines such as Google, Equifax, Experian, Yahoo, and the like. In one embodiment, the user specific information 223 may be obtained by performing an internet search with the user ID 218 and the device ID 216. For example, the search may include social media sites, search engines, online public records, and the like.

As shown at 223 of FIG. 3B, in one embodiment the user specific information 223 is provided via return information 12 to user specific info engine 220 and then passed on to credit account builder 230 as discussed herein and shown in FIG. 1A.

In one embodiment, if no user specific information 223 is found by secondary source engine 28, or if the user specific information 223 found does not reach the threshold of the confidence factor, the user specific info engine 220 will receive a return empty 39.

With reference now to 325 of FIG. 3A, one embodiment utilizes user specific information 223 to perform a credit screening. In one embodiment, the credit screening is performed based on information obtained from a credit reporting agency. However, in another embodiment, the credit screening will be based on other aspects, such as, but not limited to, the user's mobile carrier account history, the user's home ownership and the like. For example, if a user is identified as being a home owner, the offer of credit can be made without need of a credit screening being performed at a credit reporting agency.

In one embodiment, as shown in FIG. 4D, the web-based credit application requesting the verification of found user information is presented with a screen 430 that includes the information being pre-filled with the information obtained by user specific info engine 220 and presented to the user. The user can confirm 431 that the information is correct, and that information will then be used to prepopulate the credit application as described herein. That is, the information such as name, address, city, state, phone number, email and the like, would be prefilled. Thus, instead of having to type in the information, the user would simply verify that the information is correct and make any changes accordingly. Similarly, if some of the information was missing, the user would be able to fill in only the missing portions without having to complete the entire form. Thus, the user would see a significant number of keystroke reduction in the pre-filled forms which would increase throughput, decrease frustration and the time needed to fill out the forms.

FIG. 4E is a screen capture 440 of a web-based credit application providing the terms and conditions as viewed on a user's computing device. The user can choose to accept and continue 441 and/or receive an email 442 that includes the information. In one embodiment, the terms and conditions would include a signature portion. Once the user signed and submitted the terms and conditions, the user would then be presented with the new account information as shown in FIG. 4F.

With reference now to 330 of FIG. 3A, once the user passes the credit screening, one embodiment provides the new credit account to the user. For example, as shown in FIG. 4F, the screen shot 450 of the new credit account is shown in accordance with an embodiment. in one embodiment, the new credit account includes a 2D code 454 that can be used by a retailer to scan and obtain the new credit account information. In addition, the screen shot 450 could include aspects such as, the name, credit limit, account number, reward information, and the like. In one embodiment, the screen shot 450 includes the option 451 of sending the digital card to the user's mobile phone and also the option of being done 452. If the user selects 451, then at FIG. 4G, a screen capture 460 of a confirmation 461 that the new credit account information has been sent to the user's mobile phone as viewed on a user's computing device.

At FIG. 4H is a screen capture 470 of a text 471 including instructions on putting the new credit account 170 into the user's mobile wallet 129 as seen on a user's mobile phone. The operation of which is shown in FIG. 2B and the accompanying discussion.

FIG. 3C is a flow diagram 375 of a method for utilizing a new credit account 170 in mobile wallet 129 of a mobile phone, to make a transaction, in accordance with an embodiment.

Referring now to 336 of FIG. 3C, one embodiment stores, at a memory of the mobile phone, a metadata file formatted for the mobile wallet 129 on the mobile phone 110. The metadata file 270 including the new credit account 170 and a token.

With reference now to 337 of FIG. 3C, one embodiment opens, with one or more processors on the mobile phone 110, the metadata file in mobile wallet 129, the opening causing new credit account 170 to be presented by the mobile phone 110. For example, after the metadata file 270 is added to the customer's mobile wallet 129, new credit account 170 would be accessible in the mobile wallet in the same way that any other items are accessed by mobile wallet 129. In one embodiment, the metadata file 270 could also include information that would make sure that the new credit account 170 opens on the top of the mobile wallet stack. For example, when the customer opened the mobile wallet application, new credit account 170 would be the first in the stack that could include other payment cards, tickets, etc.

With reference now to 338 of FIG. 3C, one embodiment utilizes the new credit account and (in one embodiment, the token) presented by the mobile phone as payment at a point-of-purchase, POS, associates mobile checkout device, etc.

For example, when the customer goes to a shop and during checkout intends to use a credit account linked to new credit account 170, the customer would present new credit account 170 to the POS (or another checkout system such as an associate's mobile phone, etc.) When new credit account 170 is presented at checkout it could include the transmission of the token via a near field communication (NFC), a scan of the new credit account 170 image, a scanning of a digital credit account identifier 454 provided with new credit account 170, etc. In general, since the new credit account 170 has already been validated the token would be provided in conjunction with the information. The token, metadata, barcode, and/or the like would be provided from the POS to the credit account provider which would validate the token and link the purchase to the appropriate customer credit account. The credit account provider would then provide the authorization for the purchase to the POS and the transaction would be completed.

In one embodiment, the transaction could also include information from the device such as user biometric information, location information (e.g., provided by a GPS), the transaction time, the transaction date, etc. In one embodiment, the location information provided by the mobile phone will include time and date stamp information. In another embodiment, the location, time and/or date could be obtained from the POS, a combination of the customer's mobile phone and the POS, etc.

In one embodiment, for the transaction to occur, new credit account 170 would be validated using the internet connection from the POS, the biometric information for the customer (as provided via a token or the like) from the customer's mobile phone, the location obtained from the mobile phone, the time, the date of the transaction initiation, the mobile phone identification number, etc.

In so doing, the security of the customer's new credit account 170 payment system would be seamless and nearly instantaneous to the customer and the associate ringing up the transaction, but would include a plurality of checks and balances performed by the credit account provider, the brand, or a fraud determining evaluator assigned to make fraud mitigation determinations and/or evaluations.

In one embodiment, once the new credit account 170 is received at the mobile wallet 129 on the user's mobile phone 110 it is instantly available to be used as a form of payment. In one embodiment, new credit account 170, will include a digital credit account identifier 454 that can be presented on display 112 of mobile phone 110. For example, digital credit account identifier 454 could be a QR code, bar code, digital image of a credit card, or other type of identifier for providing credit account information digitally to a POS.

One example of a digital credit account identifier 454 may include: the user's name, credit limit, store card account number, terms of use, a rotating GIF to prevent screenshots from being accepted at POS, a banner asking customer to present their ID to the associate to use the new credit account, or the like.

### Fraud Detection

With reference now to FIG. 5, a block diagram of a system for fraud detection is described in accordance with an embodiment. In general, system 500 includes a fraud determination module 505 which receives address information from the location information evaluator 104 which determines the address from the raw location information 103 provided by mobile phone 110. System 500 also includes cloud 226 which may be any type or wired or wireless network connection including private, public, Local, Wide, Internet, and the like.

In one embodiment, fraud determination module 505 is a rules based fraud determination engine, that can change the weighting of risk factors, etc. For example, the credit application accessed from a non-phone computing device provides a first authentication (e.g., a non-phone computing device ID) and a user ID. The inclusion of a phone number in the credit application process allows for a second factor authentication (e.g., a mobile phone ID). However, if the information provided to the web credit application, e.g., the name, address, phone number, email, etc. does not match the fraud determination module can provide that a first weight. In another example, if the non-phone computing device is at a first location, and the second factor authentication (e.g., the mobile phone) is in a different location (or a certain distance away from) the non-phone computing device, fraud determination module 505 can provide that a second weight that is different than the first weight.

In one embodiment, the user ID and/or the device ID information that is obtained can be used to evaluate for fraud. For example, the user ID that is provided to the application process is ranked or evaluated for its fraud potential. For example, 1 is the lowest fraud risk and 10 is the highest. If the user's zip code is provided it may be ranked at a 7 out of 10 for fraud. In contrast, if the last 6 of the user's SSN is provided it may be ranked at a 2 out of 10 for fraud.

Similarly, the device ID that is provided to the application process is ranked or evaluated for its fraud potential. For example, 1 is the lowest fraud risk and 10 is the highest. If the mobile number is provided it may be ranked at a 5 out of 10 for fraud. In contrast, if the non-phone computing device UUID is provided it may be ranked at a 2 out of 10 for fraud.

The fraud risk is then evaluated. The evaluation could be for one of the identifiers, for both of the identifiers, or for a combination of the identifiers. For example, in one embodiment when the fraud scale is base 10, the single identifier fraud risk would be evaluated as low if it is a 3 or below, medium if it is between 4-5, high if it is between 6-8, and unacceptable if it is 9 or above.

If both of the fraud rankings are added together the scale could remain the same or could be different. For example, the scale remain the same, could be doubled, could have the range changed such that 15 (or whatever value is selected) is the new top range, etc. For example, the fraud risk for the combined value (using a top range of 15) would be evaluated as low if it is a 4 or below, medium if it is between 5-8, high if it is between 9-11, and unacceptable if it is 12 or above.

In another embodiment, the scale could be out of any number, e.g., 20, 50, 100, etc. depending upon the desired granularity. In one embodiment, there could be an additional level of granularity if the resultant fraud risk was at a certain level (e.g., a 6 could cause additional evaluation to determine a finer granularity of 6.3 or 6.6).

In one embodiment the result of the fraud risk determination controls at least one aspect of the new credit account. For example, if the fraud risk determination result is low, the fraud determination does not interfere with the amount of credit available on the new credit account.

In contrast, when the result of the fraud risk determination is medium, the amount of credit available on the new credit account may be reduced (for example the user would qualify for a credit limit A, the credit limit would be reduced by fraud risk amount (or percentage, or the like) B, resulting in an initial credit limit of A-B (or A reduced by B %, or the like). Similarly, when the result of the fraud risk determination is high, the amount of credit available on the new credit account is again reduced based on the fraud risk. In one embodiment, the reduction of the credit limit is only for a probationary time period, such as until the fraud risk is deemed to be lower.

In one embodiment, if the fraud risk determination is unacceptable the application process will deny the customer from receiving the new credit account. In one embodiment, if the fraud risk determination is unacceptable the application process will deny the customer from continuing the application process for the new credit account. In one embodiment, if the fraud risk determination is unacceptable the application process will not provide any automatic prefilling of the application and flag the application for the new credit account.

Consider the following example for purpose of clarity. In the following examples, the scale for a single risk factor is 10 and the combination of risk factors is 15.

A. The user's zipcode is provided and is ranked at a 9 e.g., an unacceptable fraud risk.

B. The last 4 of the user's SSN is provided and is ranked at a 2 e.g., a low fraud risk.

C. The mobile number is provided and is ranked at a 5 e.g., a medium fraud risk.

D. The non-phone computing device UUID is provided and is ranked at a 2 e.g., a low fraud risk.

### Example 1

If user ID ‘A’ (risk level 9) and device ID ‘C’ (risk level 5) were provided, the fraud determination would be an unacceptable user ID fraud risk, and a medium device ID fraud risk. If the fraud determination was based on the highest single fraud determination, then the fraud determination would result in an unacceptable fraud risk. In one embodiment, this would stop the application process and the user would be denied.

### Example 2A

If user ID ‘A’ (risk level 9) and device ID ‘C’ (risk level 5) were provided, the fraud determination would be an unacceptable user ID fraud risk, and a medium device ID fraud risk. In one embodiment, the application could request a second user ID ‘B’ (risk level 2). After the user provided information user ID ‘B’, in one embodiment, the user ID fraud risk would become a risk level 2. If the fraud determination was based on the highest single fraud determination, then the fraud determination would result in medium fraud risk (risk level 5). In one embodiment, this would allow the application process to be completed but the user would receive a credit account that may or may not have a reduced credit limit (e.g., 1,000-dollar limit, etc.).

### Example 2B

In one embodiment, the user ID and/or device ID is used during a look-up process for identifying the user and obtaining user information. The user information would be the information necessary for completing the application and/or the prequalification process. In one embodiment, user ID ‘A’ would be compared with the additional user information. If user ID ‘A’ (risk level 9) correlates with the user information, this could cause a further risk level reduction from the risk level 5 in example 2A to the low fraud risk level 4. In so doing, the user would not receive a reduced initial credit limit.

### Example 3

If user ID ‘A’ (risk level 9) and device ID ‘C’ (risk level 5) were provided, the fraud determination would be an unacceptable user ID fraud risk, and a medium device ID fraud risk. If the fraud determination was based an amalgamation of two or more of the fraud components, then (in one non-weighted embodiment) the fraud determination would result in a risk level 14 which would result in an unacceptable fraud risk. In one embodiment, this would stop the application process and the user would be denied.

### Example 4A

If user ID ‘A’ (risk level 9) and device ID ‘C’ (risk level 5) were provided, the fraud determination would be an unacceptable user ID fraud risk, and a medium device ID fraud risk. In one embodiment, the application could request a second device ID ‘D’ (risk level 2). After the user provided information D, in one embodiment, the device ID fraud risk would become a risk level 2. If the fraud determination was based an amalgamation of two or more of the fraud components, then (in one non-weighted embodiment) the fraud determination would result in a risk level 11 which would be a high fraud risk. In one embodiment, this would allow the application process to be completed but the user would receive a credit account with a reduced credit limit (e.g., 500 dollar limit, etc.).

### Example 4B

In one embodiment, the user ID and/or device ID is used during a look-up process for identifying the user and obtaining user information. The user information would be the information necessary for completing the application and/or the prequalification process. In one embodiment, device ID ‘C’ would be compared with the additional user information. If device ID ‘C’ (risk level 5) correlates with the obtained user information, this could cause a further risk level reduction from the high fraud risk level 11 in example 4A to the medium fraud risk level 8. In one embodiment, this would allow the application process to be completed but the user would receive a credit account that may or may not have a reduced credit limit (e.g., 1,000-dollar limit, etc.).

### Example X

If user ID ‘A’ (risk level 9) and device ID ‘C’ (risk level 5) were provided, the fraud determination would be an unacceptable user ID fraud risk, and a medium device ID fraud risk. In one embodiment, the application could request a second user ID ‘B’ (risk level 2). After the user provided information user ID ‘B’, in one embodiment, the user ID fraud risk would become a risk level 2. In one embodiment, the application could request a second device ID ‘D’ (risk level 2). After the user provided information D, in one embodiment, the device ID fraud risk would become a risk level 2.

If the fraud determination was based on the highest single fraud determination, then the fraud determination would result in low fraud risk (risk level 2).

If the fraud determination was based an amalgamation of two or more of the fraud components, then (in one non-weighted embodiment) the fraud determination would result in a risk level 4 which would also be a low fraud risk.

Further, the user ID and/or device ID is used during a look-up process for identifying the user and obtaining user information. In one embodiment, user ID ‘A’ and device ID ‘C’ would be compared with the obtained user information. If user ID ‘A’ and device ID ‘C’ correlate with the obtained user information, this would provide a further fraud risk level reduction. In contrast, if one or both of user ID ‘A’ and device ID ‘C’ did not correlate with the obtained user information, this could result in an increase in the fraud risk level. In one embodiment, the increase could be to a next higher level. In one embodiment, the user may be asked about the lack or correlation.

In one embodiment, if one or both of user ID ‘A’ and device ID ‘C’ did not correlate with the obtained user information, the non-correlated information could be manually or automatically evaluated to determine if the lack of correlation is due to a clerical, typographical, or accidental error. For example, if user ID ‘A’ did not correlate, it would be evaluated. If the user input user ID ‘A’ was zip code 12555 and the obtained user information is zip code 12255, it may be evaluated as a user input error and no fraud risk escalation would be made. In contrast, if the user input user ID ‘A’ was zip code 96896 and the obtained user information is zip code 12255, it would be evaluated as a deceitful input and the fraud risk escalation would be made or additional fraud risk evaluations would occur.

Thus, the fraud determination could be set as the highest fraud ranking of the highest fraud component, it could be set as an amalgamation of two or more of the fraud components, it could be adjusted based on the following additional fraud determination factors, it could be set as a weighted value for one of the user ID versus the Device ID, e.g., the user ID ranking carries 20% weight and the device ID carries an 80% weight, etc. Of course, the weighting could be ID dependent, set to different values, or the like.

In addition to the device ID and user ID fraud determination discussed above, there could be additional fraud determinations factors that are described below and can be used to modify the fraud risk determination.

### Additional Fraud Determination Factors

After user is identified and the user information is obtained, the user information will be evaluated to determine if the user's information in the account center has had recent changes to home address, email, phone number, etc. If there is, then additional fraud evaluation will occur.

For example, a static IP address correlated with particular MAC address would have a low fraud risk. In contrast, a MAC address that changes with respect to a static IP address would have a higher fraud risk. In one embodiment, if the static IP address includes a certain number of different MAC addresses (e.g., more than 2, 5, 10, 20, etc.) then the fraud risk would be weighted based on the number of different MAC addresses received from the static IP address.

### Known Fraudulent Address

In one embodiment, the location where the applicant completed the application is determined by location information evaluator 104 from the location information 103 provided by the mobile phone 110. The location information evaluator 104 would evaluate the real-time location information 103 and cross-reference the real-time location information 103 with the one or more different coordinate-to-address determination sources 517, to generate a likely address. Similar to above, if the accuracy of the location information is high enough, a complete address for where the applicant completed the application will be obtained. If the accuracy of the location information is not high enough, then a general area for where the applicant completed the application will be obtained.

In one embodiment, fraud determination module 505 will access a database 525 of known fraudulent addresses and compare the location where the application was completed with the known fraudulent addresses found in the database. Fraud determination module 505 will determine, based on the comparing, whether the location where the application was completed is found in the database 525 of known fraudulent addresses. If the location where the application 193 was completed is found in the database 525 of known fraudulent addresses the credit application will be denied and no credit account 545 will be established. In contrast, if the location where the application 193 was completed is not found in the database 525 of known fraudulent addresses the credit application will pass the fraud determination and the application will be passed to account generator 160 who will evaluate the application 193 and issue a credit account 270.

If the location where the application 193 was completed cannot be defined specifically enough to ensure that it is not a match for, or not found in, the addresses of database 525 of known fraudulent addresses, then the fraud determination module 505 will be able to make a number of choices. For example, if the general location where the application 193 was completed is in an area that includes a threshold number (e.g., 4 within the same block, etc.) of known fraudulent addresses, fraud determination module 505 will deny the credit application and no credit account 545 will be established. In contrast, if the general location where the application 193 was completed is in an area that includes no known fraudulent addresses, fraud determination module 505 may pass the credit application to account generator 160 with a small fraud determination resulting in a suggestion that the initial credit amount be lowered accordingly. However, if the general location where the application 193 was completed is in an area that includes less than a threshold number (e.g., 2 within the same block, etc.) of known fraudulent addresses, fraud determination module 505 may pass the credit application to account generator 160 with a medium fraud determination resulting in a suggestion that the initial credit amount be lowered significantly.

In one embodiment, lowered accordingly may mean a reduction of 10-20% from what would have been the initial credit amount while lowered significantly would mean a reduction of 50-75% in the initial credit amount. However, it should be appreciated that these percentages are one example. The risk aversion of the credit account provider may cause and increase or decrease in the percentages and even turn the medium risk applications into rejections such that no credit account 545 is established.

### Previously Used Addresses

In one embodiment, fraud determination module 505 will access a database 535 of previously used addresses and compare the location where the application was completed with the previously used addresses found in the database. Fraud determination module 505 will determine, based on the comparing, whether the location where the application was completed is found in the database 535 of previously used addresses.

If the location where the application 193 was completed is not found in the database 535 of previously used addresses the credit application will pass the fraud determination and the application will be passed to account generator 160 who will evaluate the application 193 and issue a credit account 270.

However, if the location where the application 193 was completed is found in the database 535 of previously used addresses, fraud determination module will determine a type of residence at the location where the application was completed. In one embodiment, the type of residence may be found in the database 535 of previously used addresses. In another embodiment, fraud determination module 505 will receive additional information about the location from the one or more different coordinate-to-address determination sources 517 via location information evaluator 104. The additional information will be used to determine the type of residency.

Fraud determination module 505 will then make a risk assessment based on a result of the determination of the type of residence.

For example, if the location where the application 193 was completed is found in the database 535 of previously used addresses and it is determined that the type of residence at that address is a single family home, then the fraud determination module 505 will be able to make a number of choices. If the number of applications received from the previously used address exceeds a threshold number (e.g., 3 within the same single family home) fraud determination module 505 will deny the credit application and no credit account 545 will be established.

In contrast, if the number of applications received from the previously used address is less than a threshold number (e.g., 2 within the same single family home) fraud determination module 505 may pass the credit application to account generator 160 with a low fraud determination resulting in a suggestion that the initial credit amount be lowered accordingly.

Similarly, if the location where the application 193 was completed is found in the database 535 of previously used addresses and it is determined that the type of residence at that address is a multi-family home (e.g., condo, townhome, apartment building, etc.), then the fraud determination module 505 will determine the number of dwellings within the multi-family home. If the number of applications received from the previously used address exceeds a threshold number (e.g., 80% of the dwellings within the multi-family home) fraud determination module 505 will pass the credit application to account generator 160 with an intermediate fraud determination resulting in a suggestion that the initial credit amount be lowered accordingly.

In contrast, if the number of applications received from the previously used address is less than a threshold number (e.g., 80% of the dwellings within the multi-family home) fraud determination module 505 will pass the credit application to account generator 160 with a low fraud determination resulting in a suggestion that the initial credit amount be lowered accordingly.

In one embodiment, if the location where the application 193 was completed cannot be defined specifically enough to ensure that it is not a match for, or not found in, the addresses of database 535 of previously used addresses, then the fraud determination module 505 would report that lack of fraud determination to account generator 160. In another embodiment, if the location where the application 193 was completed cannot be defined specifically enough to ensure that it is not a match for, or not found in, the addresses of database 535 of previously used addresses, then the fraud determination module 505 would deny the application and no credit account 545 would be established.

However, it should be appreciated that these solutions to the problem that occurs when the location where the application 193 was completed cannot be defined specifically enough may be defined differently based on the risk aversion of the credit account provider. For example, the credit account provider may provide specific guidance such as an increase or decrease in the percentages, turn the medium risk applications into rejections such that no credit account 545 is established, or turn the rejections into some level of risk such that a credit account 270 is opened.

### Store Attribution

In one embodiment, as described previously, the location where the applicant completed the application is determined by location information evaluator 104 from the location information 103 provided by the mobile phone 110. The location information evaluator 104 would evaluate the real-time location information 103 and cross-reference the real-time location information 103 with the one or more different coordinate-to-address determination sources 517, to generate a likely address. Similar to above, if the accuracy of the location information is high enough, a complete address for where the applicant completed the application will be obtained. If the accuracy of the location information is not high enough, then a general area for where the applicant completed the application will be obtained.

In one embodiment, location information evaluator 104 will access a database 555 of retail location addresses and compare the location where the application was completed with the retail location addresses found in the database. Location information evaluator 104 will determine, based on the comparing, whether the location where the application was completed is found in matches a retail location address. If the location where the application 193 was completed does match a retail location address, location information evaluator 104 will automatically provide store attribution to the retail store associated with the retail location address.

### Location Information for Fraud

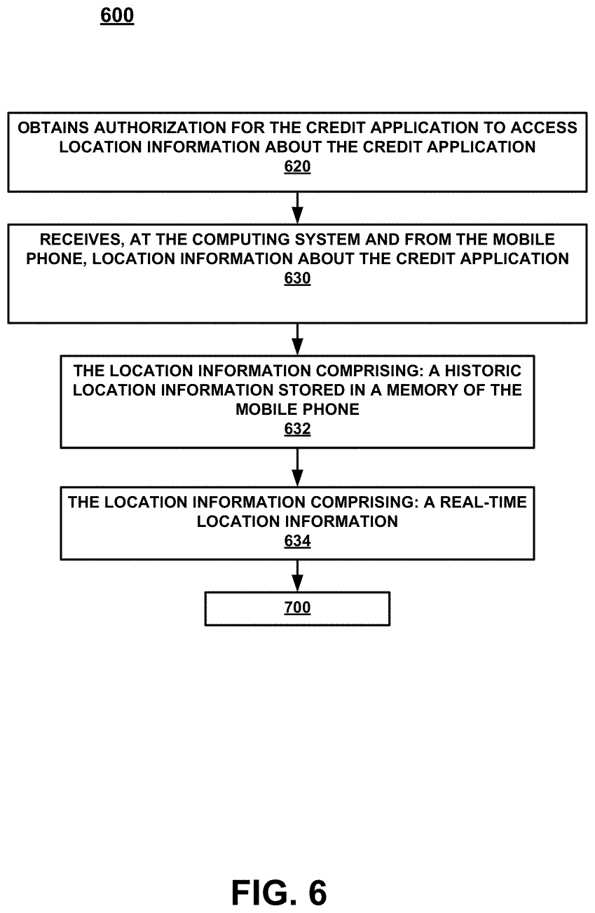

With reference now to FIG. 6, a flowchart 600 of a method for using position location information to fraud check a credit application is shown in accordance with an embodiment.

With reference now to 620 of FIG. 6, one embodiment obtains authorization for the application 193 to access location information 103 about the credit application.

With reference now to 630 of FIG. 6, one embodiment receives, at the computer system location information 103 about the credit application. In one embodiment, the location information 103 generated by a positioning system tracking such as GPS 218 on the mobile phone 110. In one embodiment, the positioning system is on the mobile phone, and is one or more of, but is not limited to, GPS, WiFi, cellular service, beacon derived location determination, NFC ranges, Bluetooth range, and the like. In another embodiment, the positioning system is virtual, that is, it is not on the mobile phone 110 but is an interface, such as a GPS chip interface, that functions with software or web applications allowing the location functionality to work outside of a traditionally defined mobile phone 110 or credit application.

Because of the different positioning systems available on a mobile phone, the location information 103 provided by one or more positioning system on the mobile phone 110 can include differing levels of accuracy. For example, a GPS enabled mobile phone 110 can provide location information 103 that is accurate to within a few meters or less. In contrast, location information 103 derived from cellular service, beacon or WiFi location capabilities of mobile phone 110 can provide a location radius or location area that may be within 10-50 meters or even larger. For example, the mobile phone 110 being located within range of a beacon at ninth street, a Wi-Fi hot-spot at a given coffee shop, within range or a single cellular service tower, within an overlapping area of a number of cellular service towers, a combination of the above, and the like.

In one embodiment, included with the location information 103 would be a level of accuracy. For example, location information 103 may be identified as having a high level of accuracy (0-5 meters), a medium level of accuracy (6-20 meters), a low level of accuracy (>20 meters), or the like. Although a number of different accuracies are discussed, it should be appreciated that there may be more or fewer levels of accuracy associated with location information 103. Further, the ranges of the different levels of accuracy disclosed may also be different based on preference, guidelines, needs, and the like.

Additionally, location information 103 may be determined by the positioning system at constant intervals, at pre-assigned time periods, when location determination commands are received, based on the use of the mobile phone 110, an application on the mobile phone 110, when a change is noted by the positioning system, and the like. Further, location information 103 may be recorded in the memory of the mobile phone every time a location determination is made by the positioning system, at constant intervals, at pre-assigned time periods, when location storage commands are received, when a change is noted in the location information 103, and the like. Likewise, the level of accuracy may be determined each time location information 103 is generated by the positioning system, only when the level of accuracy has changed, at certain intervals of location information 103 generation, or the like.

At 632, location information 103 includes historic location information stored in a memory of the mobile phone. Historic location information refers to location information 103 that is not real-time location information. Historic location information will include a date/time stamp. The historic location information would allow the stored location information to be searched, sorted, and evaluated. In one embodiment, the historic location information includes all location information 103 stored on the memory of the mobile phone 110. This may range back as long as the applicant has owned the mobile phone. In another embodiment, the time range for the historic location information is limited. For example, the location data may only be obtained for a pre-defined time range, e.g., the past 2 years, 1 year, 6 months, 3 months, 3 weeks, 5 days, etc. Although a number of time ranges are provided, it should be understood that the time range may be user definable, application pre-defined, established by the credit provider, established by law or statute, state or country dependent, or the like.

At 634, location information 103 includes real-time location information obtained from the positioning system. Real-time location information would be location information 103 that is generated in real time by the positioning system. The real-time location information would be constantly replaced as location information 103 generated by the positioning system is received at the computer system, e.g., location information evaluator 104.

In one embodiment, location information 103 provided by mobile phone 110 is coordinate data. Therefore, to determine an address, the coordinate data is cross-referenced with one or more different coordinate-to-address determination sources such as: mapping software, surveyor data that includes business and/or residential information, County assessor's information, or other coordinate-to-address determiners.

Included with location information 103 would be the level of accuracy of the location information. As such, when the location information coordinate data is cross-referenced with the one or more different coordinate-to-address determination sources, the resulting address may be specific or may be a general ballpark area.

The high level of accuracy indication about the coordinate data would likely allow a specific address to be determined when location information 103 is cross-referenced with the one or more different coordinate-to-address determination sources.

The medium level of accuracy indication about the coordinate data may allow a specific address to be determined when location information 103 is cross-referenced with the one or more different coordinate-to-address determination sources, or may result in a general address area. The determination would be based on the actual level of accuracy, the density of businesses and residences within the radius of the location information, and the like. For example, in an area with houses on acre plots, the medium level of accuracy would indicate a specific house. However, in an area with clusters of businesses, such as a strip mall, the medium level of accuracy may only be able to narrow the business address to one of a few different possibilities.

In except for the most rural cases or largest company buildings, the low level of accuracy indication about the coordinate data would not allow a specific address to be determined when location information 103 is cross-referenced with the one or more different coordinate-to-address determination sources. However, even at the low level of accuracy the number of possible street names for a home or business address would be reduced.

In one embodiment, the applicant's likely home location is determined from location information 103 provided by mobile phone 110. The computer system, e.g., location information evaluator 104, would evaluate the historical location information received from the device for a plurality of prior overnight time periods over a plurality of different nights. For example, location information 103 can be organized into time periods, e.g., midnight to 5 am and then reviewed for a prior time period, e.g., weeks, months, etc.

The likely home location is then determined based on the historical location information evaluation. For example, by sorting and then tallying the locations of mobile phone 110 during the selected time period for e.g., the past 45 days, it is likely that the location that is found most often is where the applicant resides at night. Thus, it is likely the applicant's home location.

The applicant's likely home location, and the associated accuracy value of location information 103, is then cross-referenced with the one or more different coordinate-to-address determination sources, to generate an address. If the accuracy of the likely home location is high enough, a complete address for the applicant's likely home is obtained. The complete address is then prefilled into the home address portion of application 193.

However, if the accuracy of the likely home location is not high enough to obtain a specific address, at least some level of information about the likely home location is obtained and provided to application 193. For example, a prefill capability for the application 193 can be simplified, or a drop down menu populated, by knowing what is local to the likely home location. As such, when the applicant is filling out the street address, the likely home location information is used to limit the number of possible streets that are offered in a drop down menu, a quick fill such as a type completion algorithm, or the like.

For example, if the applicant starts typing with the letter ‘M’, the limited number of possible streets within the likely home location area will cause application 193 to offer only those M street names. In this example, Maple, Moore, and Murray. After the applicant types ‘M’, the application will present the applicant with the prefill options of Maple, Moore, and Murray, from which the applicant can select. Alternatively, if the applicant continues by typing a ‘u’, the prefill will complete Murray as it is the only street within the likely home location containing those starting letters. Similarly, in the drop down menu context, every street name within the likely home location would be provided in the drop down menu and the applicant would select the correct street name from the drop down menu.

Likewise, the applicant's likely work address is determined from location information 103 provided by mobile phone 110. The computer system, e.g., location information evaluator 104, would evaluate the historical location information received from the device for a plurality of prior daytime periods over a plurality of different days. For example, the location information 103 can be organized into time periods, e.g., 9 am to 4 pm and then reviewed for a prior time period, e.g., weeks, months, etc.

A likely work address is then determined based on the historical location information evaluation. For example, by sorting and then tallying the locations where mobile phone 110 was located during the selected time period for e.g., the past 30 days, it is likely that the location that is found most often is where the applicant works. Thus, it is likely the location of the applicant's work address.

Similar to above, the applicant's likely work location, and the associated accuracy value of location information 103, is then cross-referenced with the one or more different coordinate-to-address determination sources, to generate an address. If the accuracy of the likely work location is high enough, a complete work address for the applicant is likely obtained. The complete work address is then prefilled into the work address portion of application 193.

As recited above, if the accuracy of the likely work location is not high enough to obtain a specific address, at least some level of information about the likely work location is obtained and provided to application 193. For example, a prefill capability for the application 193 can be simplified, or a drop down menu populated, by knowing what is local to the likely work location. As such, when the applicant is filling out the street address, the likely work location information is used to limit the number of possible streets that are offered in a drop down menu, the quick fill type completion algorithm, or the like.

It should be appreciated that information for a number of different locations can be obtained in the same manner as described above. For example, the historical location information could be used, by the computer system, to determine an amount of time that the applicant has spent at a retail store location. The amount could be the total amount of time, the amount over the past month, week, or the like. If the amount of time surpasses an established threshold, the credit account 270 would receive a recommendation for an initial credit limit increase for the applicant.

Thus, the location information can be used to determine one or more of: a full or partial home address, a full or partial work address, a location where the application was completed, locations where the applicant spends a lot of time, locations where the applicant does not go, and the like.

### Verification/Risk Assessment/Fraud Detection

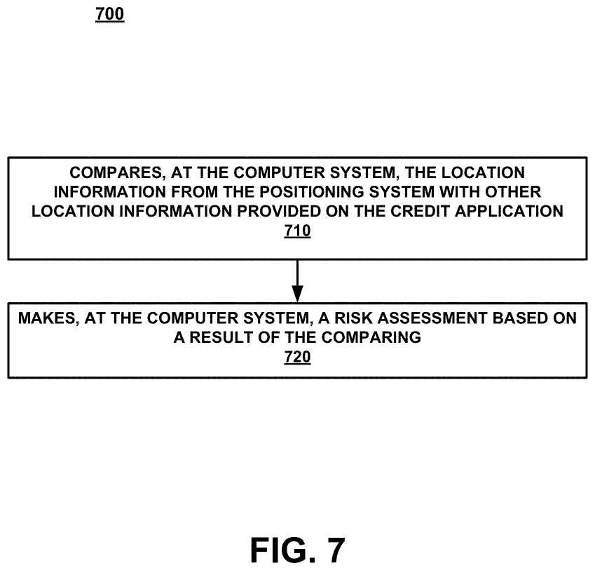

With reference now to 710 of FIG. 7, one embodiment compares, at the computer system, e.g., location information evaluator 104, the location information from the positioning system with other location information provided on the credit application 193.

In one embodiment, the other location information provided within the credit application 193 is information provided by the applicant. Additionally, application 193 could include other location information obtained from a driver's license scan or search, from a search utilizing the mobile number provided by the mobile phone, from the user specific info engine 220 of FIG. 1B which uses some applicant identification and/or device identification information to perform a search for information. One or more of the sources may provide the resultant information into the application 193.

### Verification

For example, location information 103 was used by location information evaluator 104 to determine that the applicant's home address is 123 Market Street. The other sources have also provided a home address of 123 Market Street to be prefilled into application 193. Since the comparing of the location information 103 obtained from mobile phone 110 with the information for the credit application obtained from another source matches, a verification of the probable home address is made.

### Updating/Replacing

In the updating example, location information evaluator 104 determined that the applicant's home address is likely 123. Market Street. However, information obtained from one or more of the other sources have provided a different home address, e.g., 99. Onion Way to be prefilled into application 193. Since the comparing of the location information 103 obtained from mobile phone 110 with the information obtained from another source result in a difference between the two possible addresses, the information obtained from the one or more other sources is replaced with the location information 103 during the prefilling of application 193.

In one embodiment, in addition to replacing the location information obtained from the one or more other sources with the location information 103 from mobile phone 110 in the application 193, the location information 103 from mobile phone 110 can also be provided to the one or more of the other sources that had provided a different address. Such that the one or more other sources, e.g., 220 et al., will contain the updated location information.

Since there are a number of home addresses found, location information evaluator 104 compares the likely home address determined from the downloaded location information 103 with the home address provided on the credit application 193.

### Risk Assessment

Referring now to 720 of FIG. 7, one embodiment makes, at the computer system, e.g., fraud determination module 505 of FIG. 5, a risk assessment based on a result of the comparing. The following discussion utilizes the home address for the comparing. However, it should be appreciated that any or all addresses determined to be of interest in the application, e.g., home, work, etc. can be subject to the comparing. However, for purposes of clarity, the following example refers to the home address.

For example, when the comparing results in a similar or a matching home address as described in the verification portion, a risk solution from the risk assessment, would likely result in a low concern for fraud, e.g., it is likely that the address in the application 193 is correct.

In contrast, when the comparing results in a dissimilarity, as described in the updating/replacing section, a risk assessment would likely result in a concern of medium or high level fraud. For example, depending upon the source that provided the conflicting location information, the level of fraud risk would likely, but not necessarily, be different. For example, if the information was input by user specific info engine 220, the difference may be due to an incorrect match with the applicant, the applicant having moved, or the like. In that case, the level of fraud risk may be set to medium which would, in one embodiment, result in the applicant receiving a credit account 270 having a reduced initial credit limit.

However, if the incorrect information was input into application 193 by the applicant, the difference is likely due to error or deceit. Thus, a risk assessment would likely result in a concern a higher fraud risk. In one embodiment, due to the higher fraud risk, the applicant would receive a denial of the credit account, e.g., no credit account 545.

Alternatively, prior to denying the credit account, the applicant may receive an additional question about the inconsistency of the home address provided in application 193. If the applicant recognizes the mistake, and changes it to a home address that matched the historical location information determination, then it is probable that the fraud risk level would be lowered to either the medium, e.g., the applicant receiving a credit account 270 having an initial credit limit reduction, or a low concern, e.g., the applicant receiving a credit account having no initial credit limit reduction.

### Manage Information

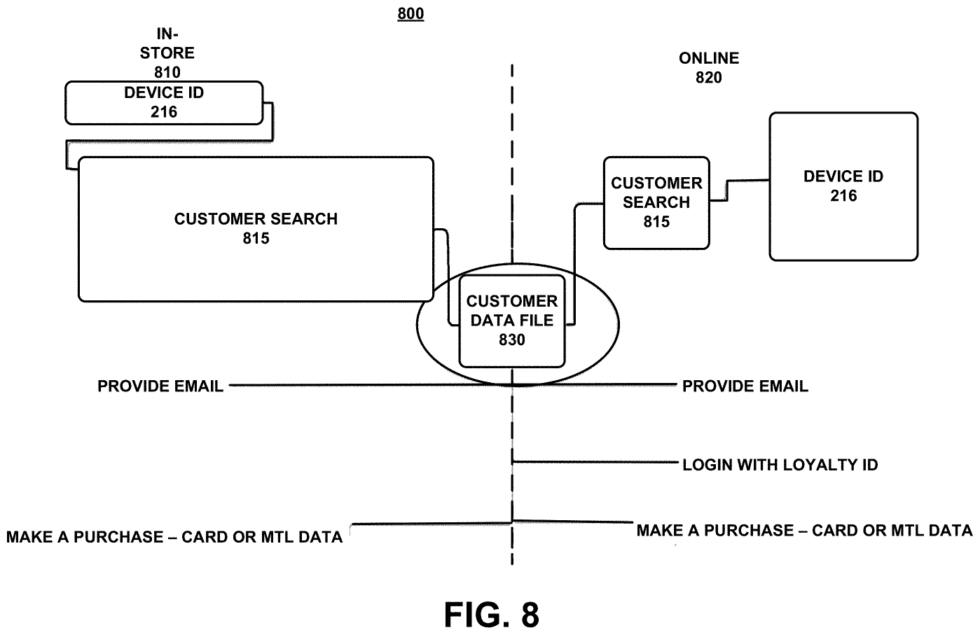

With reference now to FIG. 8, a flow diagram 800 for managing information pertaining to anonymous and/or known customers activity both in store and online is shown in accordance with an embodiment.

The following discussion of FIG. 8 will describe embodiments for allowing a retailer to connect a customer's identified and anonymous shopping behaviors (browsing, searching, etc.). In one embodiment, the customer's identified and anonymous shopping behaviors are in an online environment (e.g., a virtual visit to the retailer's site). In another embodiment, the customer's identified and anonymous shopping behaviors are in a physical environment (e.g., a physical store visit, the real world, etc.). In one embodiment, the customer's identified and anonymous shopping behaviors are in both the online environment and the physical environment.

For example, the unidentified information would include information when the customer is browsing online (without logging in, without making a purchase, etc.) or browsing in the store. In one embodiment, the unidentified browsing in the store information could include a location, an amount of time the customer was in the store, the department(s) they visited, and the like.

In one embodiment, once the unidentified browsing in the store information is assigned to the identified customer, the now identified browsing information can be used in conjunction with the known customer information to determine if the customer made a purchase during the visit, and/or a ratio of the number of times the customer visits versus the number of times the customer makes an instore purchase. The combined customer information can also be used to determine the efficacy of sales or offers that were offered by the retailer. For example, by comparing the identified browsing information with the customer's purchase information to determine a marketing-to-purchase correlation.

In another embodiment, the previously unavailable customer data can be used to evaluate a “marketing type” for the given customer. For example, if the customer is driven by offers provided from an app, from advertisement on social media, from in-store marketing such as posters, signage, etc., and the like. For example, customer A has made purchases that correlated to 5 app offers and 1 in-store marketing offer; while customer B has made purchases that correlated to no app offers and 7 in-store marketing offers.

In one embodiment, by being able to identify and correlate the customer's previously anonymous retailer interactions with the customer's identified retailer interactions, the retailer can tailor the customer's profile using the previously unavailable information. For example, the tailoring of the customer profile can include information such as, but not limited to, customer likes/dislikes, best marketing avenues, overall marketing effectiveness/response, and the like.

Moreover, by using an embodiment, the tailored customer profile would include previously unavailable information about the customer's shopping style. In general, a customer's shopping style would include (online and/or in-store) information about the customer such as, average browsing time, visits versus purchases, online versus in-store browsing ratio, online versus in-store purchase ratio, non-marketed purchases versus marketed purchases, and the like.

Thus, prior to the technology disclosed herein, the customer's shopping style would be based on a questionnaire, survey, etc. However, by looking at the customer's actual retailer interactions and behaviors, a much more accurate customer shopping style can be established. Further, any changes that occur in the shopping style could be identified and the customer profile could be adjusted accordingly. For example, customer A visits (online and/or in-person) the retailer once (or more times) a week (a day/etc.), browses for approximately half an hour and occasionally makes purchases. In contrast, customer B visits (online and/or in-person) the retailer once a month, for no more than 15 minutes and almost always makes a purchase. Of course, it should be appreciated that there could be any number of metrics that are used to develop the customer profile, the examples of customer A and B are provided as one embodiment and for purposes of clarity.

At FIG. 8, customer behavior is shown in an in-store 810 (or physical store visit) environment and/or an online 820 environment. In one embodiment, the customer search 815 will use any or all of the different search capabilities discussed with regard to FIGS. 1B-3C. In one embodiment, customer information is obtained from, for example, a customer's terms of service (TOS) acceptance.

In one embodiment, the customer data file 830 will include customer information such as the customer's device IDs. In one embodiment, the customer's data file 830 will include the device ID 216 from the mobile phone 110 and/or the customer's computing device 101 as shown and described in FIGS. 1A-2B herein. Embodiments of the present invention then utilize the received (and potentially “anonymous”) customer information in combination with various additional information, to connect a customer's anonymous behavior (online or instore) with a customer's stored/known behavior.

With regard to the in-store 810 environment, in one embodiment, when the customer enters (or approaches, nears, is within a certain distance of, is identified by a store beacon, a geofence, or the like.) a device ID 216 which includes unique identifying information is obtained. In one embodiment, this is accomplished by obtaining the device ID 216 of the initially anonymous (or unknown/unidentified) customer's mobile device from, for example, an access point (AP) which communicates with the customer's mobile device when the customer is at the retail establishment.

In one embodiment, the device ID 216 (or user ID 218) could be obtained from an app 193 operating on the customer's mobile device. In one embodiment, for example, the App 193 would identify the retail store AP via an AP ID (such as a mac address, device name, or the like), a shared key, or other retail AP identifier. The App 193 would then provide information that the device ID 216 (or user ID 218) is at the retail location. In one embodiment, at customer search 815, the device ID 216 is then compared against a customer database to identify the initially anonymous customer with a known customer's mobile device. In so doing, personally identifiable information (PII) from a database or information provider which links such PII with the device ID 216 would be obtained. After obtaining the PII information, embodiments of the present invention link the actions of the customer with the stored/known behavior corresponding to the particular customer. As such, the previously unidentified customer would be identified as the known customer correlated with the device ID 216 (or user ID 218) with a certain customer data file 830.

In one embodiment, the identification of the customer would not initiate any overt response or interactions between the customer and the retail establishment. For example, associates would not be notified, and the customer's anonymity in the store at the time of the visit would be maintained. In other words, in one embodiment, the customer's shopping experience would not be altered, it would merely be noted in the customer's data file 830. As such, the customer could join the program or otherwise authorize the release of the device ID 216 or the operation of the App 193 knowing that it would not incur any overt actions, interactions, or the like. At the same time, the retailer would be able to add valuable shopping metrics to the customer's data file 830 and use the previously unavailable information as discussed herein.

In the online 820 environment, when the customer accesses the retailer's web site, one embodiment obtains a device ID 216 which includes unique identifying information for the customer's mobile phone 110, or computer 101. In another embodiment, the customer's device is identified by a cookie (or token or other identifier) that is left on the customer's device.

In one embodiment, the device ID 216 (or user ID 218) is obtained from an App 193 operating on the customer's mobile device or computer. In one embodiment, for example, the App 193 would provide the device ID 216 (or user ID 218) to the retail website.

In one embodiment, at customer search 815, the device ID 216 is then compared against a customer database (as described in FIG. 2B) to identify the initially anonymous customer with a known customer's mobile or computing device. In so doing, personally identifiable information (PII) from a database or information provider which links such PII with the device ID 216 would be obtained. After obtaining the PII information, embodiments of the present invention link the online actions of the customer with the stored/known behavior corresponding to the particular customer. As such, the previously unidentified customer browsing activity would be identified as the browsing activity of the known customer correlated with the device ID 216 (or user ID 218) with a certain customer data file 830.

In one embodiment, the identification of the customer would not initiate any overt response or interactions between the customer and the retail website. For example, the customer would not be logged in, or otherwise identified, and the customer's anonymity on the website at the time of the visit would be maintained. In other words, in one embodiment, the customer's shopping experience would not be altered, it would merely be noted in the customer's data file 830. As such, the customer could join the program or otherwise authorize the release of the device ID 216 or the operation of the App 193 knowing that it would not incur any overt actions, interactions, or the like. At the same time, the retailer would be able to add valuable shopping metrics to the customer's data file 830 and use the previously unavailable online browsing information as discussed herein.

As a result, embodiments of the present invention link information pertaining to an initially anonymous in-store/online customer with stored/known in-store/online behavior corresponding to that particular “initially anonymous” and now identifiable customer. Hence, embodiments of the present invention thereby provide further identifying information which can be used, for example, for the purpose of personalized marketing and retailer analytics.

Thus, various embodiments will provide previously unavailable, inaccessible information about the customer's interactions with the retailer, to the retailer (or another party). That is, one embodiment connects otherwise anonymous, unidentified browsing information to the customer (who in one embodiment is known to the retailer). In so doing, the retailer will be able to use the customer's browsing information and/or the customer's browsing of a retailer's physical location to better provide for the customer's desires, wants, needs, or the like. Moreover, the retailer will be able to use the customer identified information to refine the customer's profile and provide better service to the customer based on the customer's interactions with the retailer in the physical and/or virtual retailer environment.

Numerous additional benefits are also realized by various embodiments of the present invention. For example, embodiments of the present invention will aid in the determining of where to credit marketing attribution. That is, embodiments of the present invention enable a retailer to determine (and compare and contrast) the success of in store and online marketing. Hence, embodiments in accordance with the present invention, identify potential opportunities for channel migration candidates. Although retailers are the recipients of the information in the discussion above, in various embodiments the information could be shared with other entities, stored and analyzed by a third party, received and utilized by a credit account provider in place of the retailer, or the like.

### Example Computer System Environment

With reference now to FIG. 9, portions of the technology for providing a communication composed of computer-readable and computer-executable instructions that reside, for example, in non-transitory computer-readable medium for storing instructions of a computer system. That is, FIG. 9 illustrates one example of a type of computer that can be used to implement embodiments of the present technology. FIG. 9 represents a system or components that may be used in conjunction with aspects of the present technology. In one embodiment, some or all of the components described herein may be combined with some or all of the components of FIG. 9 to practice the present technology.

FIG. 9 illustrates an example computer system 900 used in accordance with embodiments of the present technology. It is appreciated that system 900 of FIG. 9 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 9, computer system 900 of FIG. 9 is well adapted to having peripheral computer readable media 1002 such as, for example, an external hard drive, a compact disc, a flash drive, a thumb drive, a wireless radio enabled device, and the like coupled thereto.

Computer system 900 of FIG. 9 includes an address/data/control bus 1004 for communicating information, and a processor 1006A coupled to bus 1004 for processing information and instructions. As depicted in FIG. 9, system 900 is also well suited to a multi-processor environment in which a plurality of processors 1006A, 1006B, and 1006C are present. Conversely, system 900 is also well suited to having a single processor such as, for example, processor 1006A. Processors 1006A, 1006B, and 1006C may be any of various types of microprocessors. Computer system 900 also includes data storage features such as a computer usable volatile memory 1008, e.g., random access memory (RAM), coupled to bus 1004 for storing information and instructions for processors 1006A, 1006B, and 1006C.

System 900 also includes computer usable non-volatile memory 1100, e.g., read only memory (ROM), coupled to bus 1004 for storing static information and instructions for processors 1006A, 1006B, and 1006C. Also present in system 900 is a data storage unit 1102 (e.g., a magnetic disk drive, optical disk drive, solid state drive (SSD), and the like) coupled to bus 1004 for storing information and instructions. Computer system 900 also includes an optional alpha-numeric input device 1104 including alphanumeric and function keys coupled to bus 1004 for communicating information and command selections to processor 1006A or processors 1006A, 1006B, and 1006C. Computer system 900 also includes an optional cursor control device 1106 coupled to bus 1004 for communicating user input information and command selections to processor 1006A or processors 1006A, 1006B, and 1006C. Optional cursor control device may be a touch sensor, gesture recognition device, and the like. Computer system 900 of the present embodiment also includes an optional display device 1108 coupled to bus 1004 for displaying information.

Referring still to FIG. 9, optional display device 1108 of FIG. 9 may be a liquid crystal device, cathode ray tube, OLED, plasma display device or other display device suitable for creating graphic images and alpha-numeric characters recognizable to a user. Optional cursor control device 1106 allows the computer user to dynamically signal the movement of a visible symbol (cursor) on a display screen of display device 1108. Many implementations of cursor control device 1106 are known in the art including a trackball, mouse, touch pad, joystick, non-contact input, gesture recognition, voice commands, bio recognition, and the like. In addition, special keys on alpha-numeric input device 1104 capable of signaling movement of a given direction or manner of displacement. Alternatively, it will be appreciated that a cursor can be directed and/or activated via input from alpha-numeric input device 1104 using special keys and key sequence commands.

Computer system 900 also includes an I/O device 1020 for coupling system 900 with external entities. For example, in one embodiment, I/O device 1020 is a modem for enabling wired or wireless communications between system 900 and an external network such as, but not limited to, the Internet or intranet. A more detailed discussion of the present technology is found below.

Referring still to FIG. 9, various other components are depicted for system 900. Specifically, when present, an operating system 1022, applications 1024, modules 1026, and data 1028 are shown as typically residing in one or some combination of computer usable volatile memory 1008, e.g. random access memory (RAM), and data storage unit 1102. However, it is appreciated that in some embodiments, operating system 1022 may be stored in other locations such as on a network or on a flash drive; and that further, operating system 1022 may be accessed from a remote location via, for example, a coupling to the internet. In one embodiment, the present technology, for example, is stored as an application 1024 or module 1026 in memory locations within RAM 1008 and memory areas within data storage unit 1102. The present technology may be applied to one or more elements of described computer system 900.

System 900 also includes one or more signal generating and receiving device(s) 1030 coupled with bus 1004 for enabling system 900 to interface with other electronic devices and computer systems. Signal generating and receiving device(s) 1030 of the present embodiment may include wired serial adaptors, modems, and network adaptors, wireless modems, and wireless network adaptors, and other such communication technology. The signal generating and receiving device(s) 1030 may work in conjunction with one or more communication interface(s) 1032 for coupling information to and/or from system 900. Communication interface 1032 may include a serial port, parallel port, Universal Serial Bus (USB), Ethernet port, Bluetooth, thunderbolt, near field communications port, WiFi, Cellular modem, or other input/output interface. Communication interface 1032 may physically, electrically, optically, or wirelessly (e.g., via radio frequency) couple computer system 900 with another device, such as a mobile telephone, radio, or computer system.

The computing system 900 is only one example of a suitable computing environment and is not intended to suggest any limitation as to the scope of use or functionality of the present technology. Neither should the computing environment be interpreted as having any dependency or requirement relating to any one or combination of components illustrated in the example computing system 900.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer-implemented method for managing information pertaining to anonymous and/or known customer activity, said method comprising:
receiving, at a computing system associated with a retailer, identification (ID) information for a user's computing device that is accessing a website of the retailer;
utilizing, at the computing system associated with the retailer, the ID information to search for and identify a customer associated with the ID information;
receiving, at a computing system associated with the retailer, browsing information for the website as performed by the user's computing device;
adding, at the computing system associated with the retailer, the browsing information to a customer data file of the identified customer; and
utilizing, at the computing system associated with the retailer, information in the customer data file to develop a customer profile for the identified customer.

2. The method of claim 1, further comprising:
utilizing a proprietary database to search for and identify the customer associated with the ID information.

3. The method of claim 2, further comprising:
utilizing a secondary source database to search for and identify the customer associated with the ID information.

4. The method of claim 1, further comprising:
obtaining authorization before obtaining the ID information for the user's computing device.

5. The method of claim 1, further comprising:
receiving a device ID for a mobile device that has entered a physical location of the retailer;
utilizing the device ID to search for and identify the customer associated with the device ID;
receiving tracking information for the mobile device, the tracking information limited to activity in the physical location of the retailer;
adding the tracking information to the customer data file of the identified customer; and
utilizing information in the customer data file to develop the customer profile for the identified customer.

6. The method of claim 5, further comprising:
obtaining authorization before obtaining the device ID for the mobile device.

7. The method of claim 5, further comprising:
building the customer data file from known information provided by the customer, the known information from the group consisting of: the device ID for the mobile device, the identification (ID) information for the user's computing device, an email address, a credit account information.

8. A non-transitory computer-readable storage medium having instructions embodied therein that when executed cause a computer system to perform a method comprising:
receiving a device ID for a mobile device that has entered a physical location of a retailer;
utilizing the device ID to search for and identify a customer associated with the device ID;
receiving tracking information for the mobile device, the tracking information limited to activity in the physical location of the retailer;
adding the tracking information to a customer data file of the identified customer; and
utilizing information in the customer data file to develop a customer profile for the identified customer.

9. The non-transitory computer-readable storage medium of claim 8, further comprising:
utilizing a proprietary database to search for and identify the customer associated with the device ID.

10. The non-transitory computer-readable storage medium of claim 9, further comprising:
utilizing a secondary source database to search for and identify the customer associated with the device ID.

11. The non-transitory computer-readable storage medium of claim 8, further comprising:
obtaining authorization before obtaining the device ID for the mobile device.

12. The non-transitory computer-readable storage medium of claim 8, further comprising:
receiving identification (ID) information for a user's computing device that is accessing a website of the retailer;
utilizing the ID information to search for and identify the customer associated with the ID information;
receiving browsing information for the website as performed by the user's computing device;
adding the browsing information to the customer data file of the identified customer; and
utilizing information in the customer data file to further develop the customer profile for the identified customer.

13. The non-transitory computer-readable storage medium of claim 12, further comprising:
obtaining authorization before obtaining the ID information for the user's computing device.

14. The non-transitory computer-readable storage medium of claim 12, further comprising:
building the customer data file from known information provided by the customer, the known information from the group consisting of: the device ID for the mobile device, the identification (ID) information for the user's computing device, an email address, and a credit account information.

15. A computing system to manage information pertaining to anonymous and/or known customer activity both in store and online comprising:
a memory; and
one or more processors, the one or more processors to:
receive a device ID for a mobile device that has entered a physical location of a retailer;
utilize the device ID to search for and identify a customer associated with the device ID;
receive tracking information for the mobile device, the tracking information limited to activity in the physical location of the retailer;
add the tracking information to a customer data file of the identified customer;
receive identification (ID) information for a user's computing device that is accessing a website of the retailer;
utilize the ID information to search for and identify the customer associated with the ID information;
receive browsing information for the website as performed by the user's computing device;
add the browsing information to the customer data file of the identified customer; and
utilize the information in the customer data file to develop a customer profile for the identified customer.

16. The computing system of claim 15, wherein the one or more processors are further to:
utilize a proprietary database to search for and identify the customer associated with the ID information and the device ID.

17. The computing system of claim 16, wherein the one or more processors are further to:
utilize a secondary source database to search for and identify the customer associated with the ID information and the device ID.

18. The computing system of claim 15, wherein the one or more processors are further to:
obtain authorization before obtaining the ID information for the user's computing device.

19. The computing system of claim 15, wherein the one or more processors are further to:
obtain authorization before obtaining the device ID for the mobile device.

20. The computing system of claim 15, wherein the one or more processors are further to:
build the customer data file from known information provided by the customer, the known information from the group consisting of: the device ID for the mobile device, the identification (ID) information for the user's computing device, an email address, and a credit account information.
